(19) United States
(12) Patent Application Publication
(10) Pub. No.: US 2026/0338540 A1
(43) Pub. Date: Oct. 29, 2026

(54) METHOD AND SYSTEM FOR OBJECT MEASUREMENT USING AUGMENTED REALITY, PHOTOGRAMMETRY, AND SENSOR FUSION SYNTHESIS

(71) Applicant: SavaQuan LLC, Boise, ID (US)

(72) Inventors: Lisha James Shippy, Meridian, ID (US); Slade Ryan Shippy, Parma, ID (US); Caleb Allen Cook, Meridian, ID (US)

(73) Assignee: SavaQuan LLC, Boise, ID (US)

(21) Appl. No.: 19/656,087

(22) Filed: Apr. 23, 2026

Related U.S. Application Data
(60) Provisional application No. 63/793,873, filed on Apr. 24, 2025.

(51) Int. Cl. G01B 11/02; G01C 11/02

(52) U.S. Cl. CPC G01B 11/022; G01C 11/02

(57) ABSTRACT

A method and system for generating accurate and consistent data related to arboriculture project scope assessment is provided to a user, which includes generating project cost estimates based on reliable, accurate, and consistent object measurement data. An object measurement interface is utilized to capture and store data associated with images of an object to be measured. A dimensions calculation module of the object measurement interface utilizes augmented reality (AR), photogrammetry, and sensor fusion synthesis in conjunction with intrinsic field of view (FOV) data, pixel density data and image analysis data to calculate dimensions of an object, which allows for generation of reliable and accurate object measurements using mathematical manipulation of camera optical properties.

### RELATED APPLICATIONS

This application claims the benefit of U.S. Provisional Patent Application No. 63/793,873, filed in the name of Lisha James Shippy, et al. on Apr. 24, 2025, entitled “METHOD AND SYSTEM FOR OBJECT MEASUREMENT USING AUGMENTED REALITY, PHOTOGRAMMETRY, AND SENSOR FUSION SYNTHESIS,” which is hereby incorporated by reference in its entirety as if it were fully set forth herein.

### BACKGROUND

Tree trimming, pruning, and removal are essential practices in arboriculture to maintain the health and appearance of trees and other surrounding vegetation. One of the key steps in providing arboriculture services successfully is performing an assessment of the vegetation to be worked on. Utilizing traditional methods, this is a time-consuming and labor-intensive process requiring performance of multiple error-prone operations.

For example, trees, vegetation objects, and/or other structures and objects on a project work site, such as gateways, overhead objects, fences, poles, buildings, and the like need to be accurately and efficiently located, identified and/or measured in order to assess the project scope. Performing a thorough assessment of the project site to determine project scope allows an arboriculture services provider to generate project cost estimates. In order to generate project cost estimates, many factors need to be taken into consideration. For example, a determination must be made as to the amount of time a project will take to complete, the type of equipment that will be needed to complete the project, and the size of the equipment that will be needed to complete the project. Further, a safety risk analysis needs to be performed, including identifying any physical obstacles on the site and checking for overhead clearance for equipment. Another important analysis involves identifying project site access points, such as driveways and gateways, and calculating drag lines and drag distances for trees. For instance, once a tree has been felled, the tree needs to be physically dragged to the location of vegetation removal equipment, such as a chipper truck, in order to properly remove the tree from the project site, which is not a trivial operation.

One of the most important factors to consider in generation of a project cost estimate for arboriculture services is the dimensions of the object on which the work operations will be performed. As one illustrative example, a common service provided by arboriculture services providers is tree removal. In order to accurately assess the project scope and generate cost estimates, in addition to the above-mentioned factors, it is important to know not only the species of the tree to be removed, but also the branch density and dimensions of the tree to be removed, such as tree height, width, and trunk diameter. While performance of arboriculture services such as those described above are relatively commonplace, traditional methods for managing arboriculture services projects and generating project cost estimates, including performing measurement calculations on relevant objects, have a number of significant drawbacks. Consequently, there is a long-felt need in the arboriculture services industry for a technical solution to the problems presented by the traditionally used methods.

As one illustrative example, using traditional methods, the process for providing arboriculture services starts with a requester/customer contacting an arborist via phone, email, or web form to request an estimate for completion of a particular project/operation. In many cases, the customer may need to wait for days or weeks to be scheduled for an estimate appointment depending on the arborist’s availability. Once the arborist becomes available, the arborist must then visit the customer’s property in person to physically inspect the vegetation and the project site to assess the scope of work required. Further, the customer must usually request time off from their work to accommodate the arborist’s schedule. During project site inspection, using traditional methods, the arborist must rely on manual performance of measurements and other calculations based mostly on visual inspection and guesswork, which can easily result in any number of inaccuracies and errors due to the unreliability of the data being obtained.

Based on the data obtained from the arborist’s inspection, which is unreliable and likely inaccurate, the arborist then writes up a detailed estimate for the customer, including a description of the proposed work, as well as details such as equipment needed, estimated hours for completion, and cost breakdown. The estimate is then delivered to the customer, either in person or electronically. Often, the estimate generated for the customer is unclear due to lack of accompanying images and/or videos. As a result, once the customer has received and reviewed the estimate, they often contact the arborist to ask for clarification and/or adjustments. This can result in multiple meetings between the arborist and the customer to review and revise the necessary paperwork. Once any necessary revisions are made and both parties agree on the terms, the estimate is finalized, and work can commence.

As described above, the drawbacks of the traditional methods for managing arboriculture services projects can often lead to significant delays in the process of providing services, and as such can be incredibly time-consuming, inefficient, and wasteful of resources. Additionally, the estimates generated by use of the traditional methods are largely unreliable, inaccurate, and/or inconsistent, which can cause significant difficulties for both the customer and the service provider.

As noted above, one of the key pieces of data needed to generate project cost estimates is the size of the object to be worked on, which is typically determined by an arborist through visual inspection of the object. While smaller, uniformly shaped objects can be measured via traditional measurement means, such as measuring tapes and the like, measurement of larger objects, particularly those of non-uniform shape, such as trees, presents a highly challenging technical problem. Further, particularly with respect to vegetation objects, such as trees, it is often the case that data in addition to the object height and width, such as branch density and trunk diameter also need to be measured.

Currently, using traditional methods, performing complex analysis of a variety of vegetation object characteristics is a challenging, time-consuming, and inefficient process. Further, there currently is no way to efficiently gather reliable, accurate, and consistent measurement data associated with an extensive number and variety of objects present in our physical environment, including trees, but also including other difficult to measure objects.

Consequently, what is needed is a solution to several long-standing technical problems faced by arboriculture services providers associated with generating accurate and consistent data related to project scope assessment, including generating project cost estimates based on reliable, accurate, and consistent object measurement data.

### SUMMARY

Embodiments of the present disclosure provide technical solutions to the long-standing technical problems associated with generating accurate and consistent data related to project scope assessment, including generating project cost estimates based on reliable, accurate, and consistent object measurement data.

In one embodiment, the present invention relates to a computer-implemented method for providing a user with a vegetation analysis tool through a user interface of an arboriculture services project management system. In one embodiment, the present invention relates to a computer-implemented method for utilizing a vegetation analysis tool to generate estimates for arboriculture services. In one embodiment, the present invention relates to a computer-implemented method for performing measurements on objects that are challenging to measure using traditional measurement mechanisms. In various embodiments, the method for performing object measurements disclosed herein allows services providers, such as, but not limited to, arboriculture services providers to efficiently generate project cost estimates based on reliable, accurate, and consistent object measurement data.

In one embodiment, an object measurement interface is provided to a user through a user interface of a project management system, which utilizes object measurement results data obtained from the object measurement interface to generate enhanced project cost estimates. In one embodiment, an object measurement interface is provided to a user as a stand-alone tool, which can be used by any type of user to measure a wide variety of objects, particularly objects that are challenging to measure using traditional measurement mechanisms.

In some embodiments, the disclosed invention includes a streamlined and efficient process for vegetation analysis, including generating enhanced project cost estimates through use of specialized image recognition libraries and machine learning algorithms to analyze data from previous work projects. In some embodiments, the disclosed process for vegetation analysis enables interpretation of complex environmental scenarios to accurately identify estimate characteristics by evaluation of multiple factors associated with the object to be worked on. For example, in the case of providing estimates for a service such as tree removal, factors such as tree size, trunk diameter, tree species, branch density, tree location, type of cuts, proximity to obstacles, accessibility of the tree, weather conditions, and local regulations may need to be factored into the estimate calculations. In one embodiment, use of the methods and systems disclosed herein allows for generation of project cost estimates that are more reliable and less prone to errors than those generated using traditional methods.

In one embodiment, the disclosed arboriculture services project management system provides end-to-end management for services such as tree services and landscaping operations, including management of client details, project details, estimate details, appointment and scheduling details, billing and accounting details, equipment details, service details, and analytics reporting.

In one embodiment, a user is provided with an arboriculture services project management system through a device of a user, which allows a user to define project specifications and identify project specifications that require vegetation analysis. In one embodiment, the user is provided with a vegetation analysis tool which guides the user through a specific process for obtaining images of vegetation objects that will be suitable for use in performing analysis of the vegetation. In one embodiment, the vegetation analysis tool processes the image data in conjunction with other relevant data to generate vegetation analysis results data, which may be utilized, for example, to calculate enhanced project cost estimates. In one embodiment, the project specification data is updated based on the results of the vegetation analysis and provided to the user of a project management user interface.

In one embodiment, the disclosed object measurement interface, which may be provided to a user as a stand-alone tool or as part of a larger project management system, solves the problem of accurately and reliably measuring objects, such as, but not limited to trees, and other objects that are challenging to measure using traditional measurement mechanisms. While the disclosed object measurement interface is specifically designed for measuring tree objects, the system is also capable of measuring a wide variety of other structures and objects, such as but not limited to, gateways, overhead objects, fences, poles, buildings, and similar structures.

In various embodiments, in the arboriculture industry, solving the problem of calculating measurements associated with vegetation objects, such as trees, takes the guesswork out of the estimation process and enables services providers to provide virtual estimates. In one embodiment, the disclosed object measurement interface can be provided to users other than arborists, contractors, and service providers, such as, but not limited to, homeowners. Providing a homeowner with access to the object measurement interface prevents unnecessary loss of man hours by allowing a contractor or other service provider to perform project site assessment remotely.

In one embodiment, a user is provided with an object measurement interface through a device of a user and the object measurement interface is utilized to capture and store image data, location data, and rotation data associated with images of an object to be measured. In one embodiment, a single-image and a multi-image image capture mode of the object measurement interface is provided. In one embodiment, data identifying the edges of the object to be measured is generated through analysis of the image data and the relevant data is provided to a dimensions calculation module of the object measurement interface.

In one embodiment, the dimensions calculation module of the object measurement interface utilizes a novel combination of augmented reality (AR), photogrammetry, and sensor fusion synthesis. In one embodiment, intrinsic field of view (FOV) data and pixel density data associated with an optical component of a user device, such as a camera, are combined with distance data and pixel distance offset data obtained through analysis of images of an object to calculate the percentage of the camera’s field of view that the object takes up. In various embodiments, this combination of data allows for generation of reliable and accurate measurements using mathematical manipulation of camera optical properties.

In one embodiment, the methods and systems disclosed herein include a computing device configured for object measurement, wherein the computing device comprises one or more optical components, an inertial measurement unit (IMU), a display screen, at least one processor, and at least one memory coupled to the at least one processor, the at least one memory having stored therein instructions which, when executed by the at least one processor, perform a measurement process.

In one embodiment, the methods and systems disclosed herein include a computer-implemented method for object measurement comprising providing a user with an object measurement interface accessible through a computing device of the user and utilizing the object measurement interface and one or more processors of the computing device to perform a measurement process.

Consequently, embodiments of the present disclosure provide technical solutions to the long-standing technical problems associated with generating accurate and consistent data related to arboriculture project scope assessment, including generating project cost estimates based on reliable, accurate, and consistent object measurement data.

### BRIEF DESCRIPTION OF THE DRAWINGS

FIG. 1A is a block diagram of a project management system for providing a user with tools to manage one or more arboriculture services projects, in accordance with one embodiment.

FIG. 1B is a flow chart of an example process for performing vegetation analysis using an arboriculture services project management system, in accordance with one embodiment.

FIGS. 1C and 1D are screenshots of a project management user interface of an arboriculture services project management environment, in accordance with one embodiment.

FIGS. 1E and 1F are screenshots of an arboriculture services project management user interface, in accordance with various embodiments.

FIG. 2A is a block diagram, which provides a simplified overview of an object measurement interface, in accordance with one embodiment.

FIG. 2B is a flowchart of a process for obtaining data to calculate dimensions of an object using a specialized object measurement interface, in accordance with one embodiment.

FIG. 2C is a flowchart of a process for calculating object dimensions using a dimensions calculation module of the object measurement interface, in accordance with one embodiment.

FIGS. 3A-3C are screenshots of an image capture portion of an object measurement interface using single-image mode, in accordance with one embodiment.

FIGS. 4A-4F are screenshots of an image capture portion of an object measurement interface using multi-image mode, in accordance with one embodiment.

FIGS. 5A and 5B are diagrams of a user capturing an image of an object in accordance with various embodiments.

FIG. 6A is a screenshot of an object edge marking portion of an object measurement interface using single-image mode, in accordance with one embodiment.

FIG. 6B is a diagram showing the process for generating object edge data in multi-image mode, in accordance with one embodiment.

FIGS. 7A-7C are screenshots illustrating portions of the object localization process, in accordance with various embodiments.

FIG. 7D is a screenshot of an object base edge marking portion of an object measurement interface using either single-image mode or multi-image mode, in accordance with one embodiment.

FIG. 7E is a screenshot of an object measurement interface, which is an illustrative example of calculated object dimensions being provided to a user, in accordance with one embodiment.

FIG. 8A is a diagram illustrating a portion of the object localization process, in accordance with one embodiment.

FIG. 8B is a diagram illustrating calculation of device vector offset 820 relative to device vector actual 818 in multi-image mode, in accordance with one embodiment.

FIG. 8C is a diagram illustrating a top-down view of a portion of the process for determining horizontal object field of view percentages, in accordance with one embodiment.

Common reference numerals are used throughout the figures and the detailed description to indicate like elements. One skilled in the art will readily recognize that the above figures are merely illustrative examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying figures, which depict one or more exemplary embodiments. Embodiments may be implemented in many different forms and should not be construed as limited to the embodiments set forth herein, shown in the figures, or described below. Rather, these exemplary embodiments are provided to allow a complete disclosure that conveys the principles of the invention, as set forth in the claims, to those of skill in the art.

As noted above, in one embodiment, the present invention relates to a computer-implemented method for providing a user with a vegetation analysis tool through a user interface of an arboriculture services project management system. In one embodiment, the present invention relates to a computer-implemented method for utilizing the vegetation analysis tool to generate estimates for arboriculture services. In one embodiment, the present invention relates to a computer-implemented method for performing measurements on objects that are challenging to measure using traditional measurement mechanisms. In various embodiments, the method for performing object measurements disclosed herein allows services providers, such as, but not limited to, arboriculture services providers, to efficiently generate project cost estimates based on reliable, accurate, and consistent object measurement data.

In one embodiment, a user is provided with an arboriculture services project management system through a device of a user, which allows a user to define project specifications and identify project specifications that require vegetation analysis. In one embodiment, the user is provided with a vegetation analysis tool which guides the user through a specific process for obtaining images of vegetation objects that will be suitable for use in performing analysis of the vegetation. In one embodiment, the vegetation analysis tool processes the image data in conjunction with other relevant data to generate vegetation analysis results data, which may be utilized, for example, to calculate enhanced project cost estimates. In one embodiment, the project specification data is updated based on the results of the vegetation analysis and provided to the user of a project management user interface.

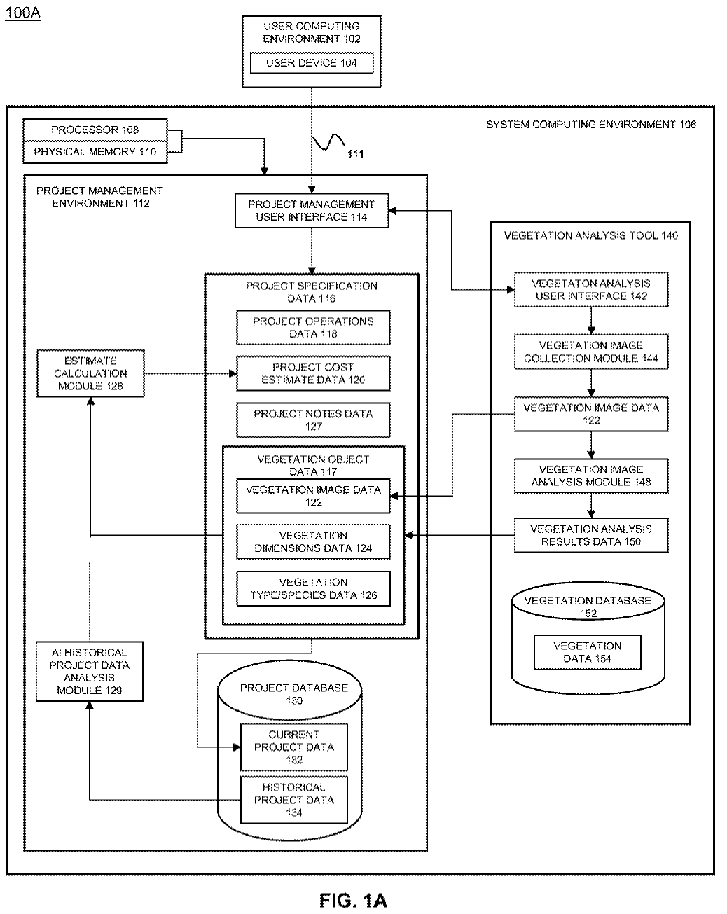

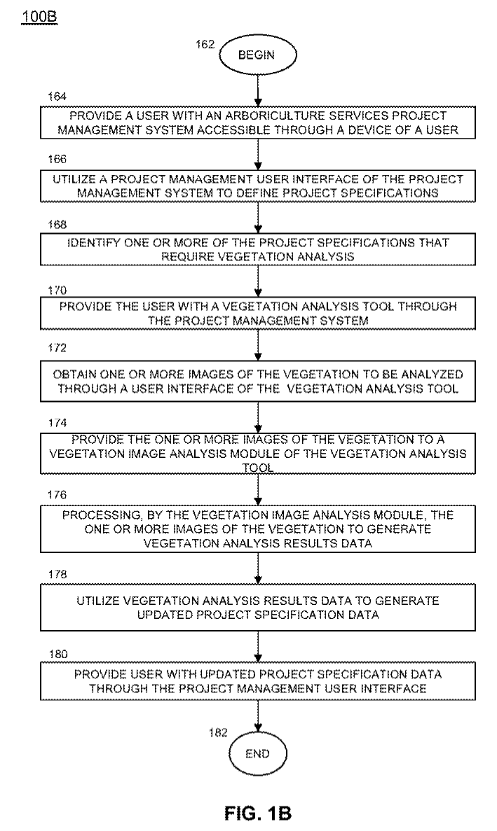

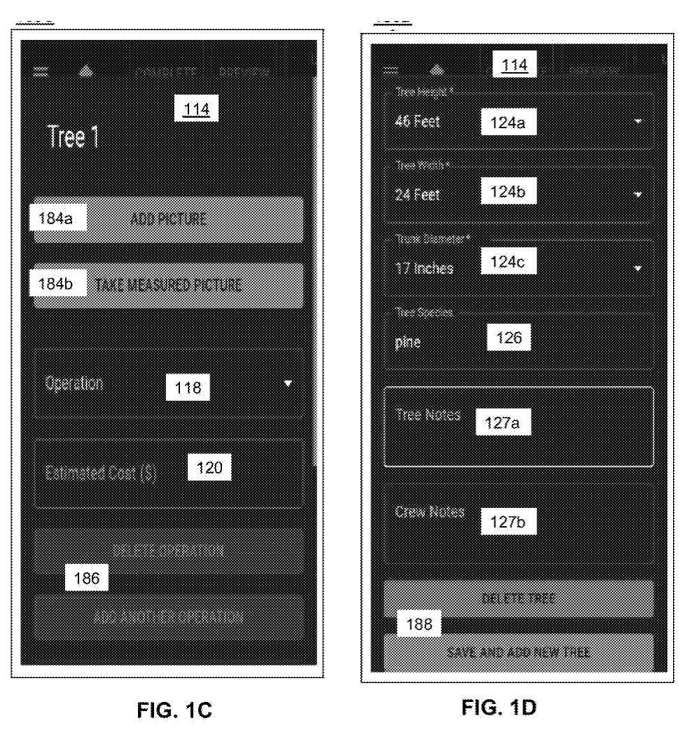

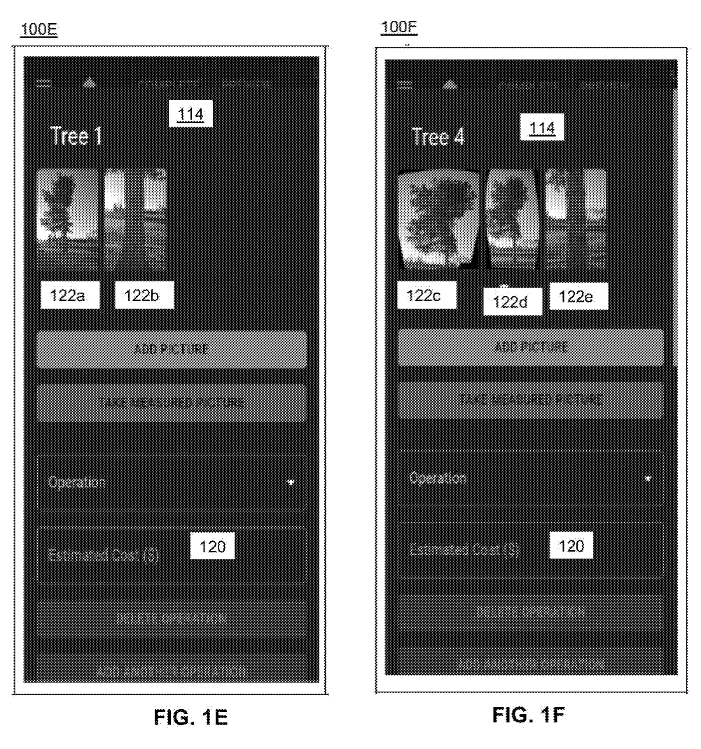

FIG. 1A is a block diagram of a project management system 100A for providing a user with tools to manage one or more arboriculture services projects, in accordance with one embodiment.

In one embodiment, system 100A includes user computing environment 102, user device 104, and system computing environment 106. In one embodiment, user computing environment 102 is communicatively coupled to system computing environment 106 via one or more communication networks 111.

In one embodiment, system computing environment 106 includes project management environment 112, vegetation analysis tool 140, one or more processors represented by processor 108 and one or more memories represented by physical memory 110. In one embodiment, processor 108 and physical memory 110 coordinate the operation and interaction of the data and data processing modules associated with project management environment 112 and vegetation analysis tool 140, as discussed herein. In one embodiment, project management environment 112 includes project management user interface 114. In one embodiment, project management user interface 114 enables user computing environment 102 and/or user device 104 to access project management environment 112 through the one or more communication networks 111.

In one embodiment, project management environment 112 further includes project specification data 116, project database 130, estimate calculation module 128, and AI historical project data analysis module 129. In one embodiment, project specification data 116 includes project operations data 118, project cost estimate data 120, project notes data 127, and vegetation object data 117. In one embodiment, vegetation object data 117 further includes vegetation image data 122, vegetation dimensions data 124, and vegetation type/species data 126. In one embodiment, project database 130 includes current project data 132 and historical project data 134. Each of the above elements will be discussed in further detail below.

In one embodiment, vegetation analysis tool 140 includes vegetation analysis user interface 142, vegetation image collection module 144, vegetation image data 122, vegetation image analysis module 148, vegetation analysis results data 150, and vegetation database 152. In one embodiment, vegetation database 152 includes vegetation data 154. Each of the above elements will be discussed in further detail below.

FIG. 1B is a flow chart of an example process 100B for performing vegetation analysis using an arboriculture services project management system, in accordance with one embodiment.

As seen in FIG. 1B, in one embodiment, process 100B begins at BEGIN operation 162 and then process flow proceeds to operation 164.

In one embodiment, at operation 164, a user is provided with an arboriculture services project management system accessible through a device of a user.

In various embodiments, the present invention utilizes a computer-implemented method and system for managing project data related to arboriculture services projects, and a user is provided with an arboriculture services project management system accessible through a device of the user. In one embodiment, the device of the user is a mobile device, and the methods and systems described herein are supported by a variety of mobile operating systems, such as, but not limited to, Android and iOS. In other embodiments, the user device can be any device, utilizing any operating system, capable of providing the disclosed functionality.

Referring to FIGS. 1A and 1B together, in one embodiment, a user is provided with access to project management environment 112 of project management system 100A through project management user interface 114, which is accessible through a device of the user, such as user device 104 of user computing environment 102.

In one embodiment, once the user is provided with an arboriculture services project management system at operation 164, process flow proceeds to operation 166. In one embodiment, at operation 166, a project management user interface of the project management system is utilized to define project specifications.

In various embodiments, the user is given the option to define any number of specifications related to an arboriculture services project. For example, the user may add project specification data 116 such as project operations data 118, project cost estimate data 120, project notes data 127, vegetation image data 122, vegetation dimensions data 124, vegetation type/species data 126 and/or any other type of project specification data desired by a user of the system.

FIGS. 1C and 1D are screenshots 100C and 100D of a project management user interface 114 of an arboriculture services project management environment 112, in accordance with one embodiment.

Referring to FIGS. 1A, 1B. and 1C together, in one embodiment, an arboriculture services project management environment, such as arboriculture services project management environment 112 includes project management user interface 114, which allows a user to define project specification data 116 related to an arboriculture services project.

As shown in FIG. 1C, in one embodiment, project management user interface 114 includes image options 184 for adding image data to the project specification data 116. In one embodiment, the user may select image option 184a, which allows the user to upload an image to the system. In one embodiment, the user may select image option 184b, which allows the user to take a measured picture of an object. The processes for adding image data and/or taking measured pictures of objects will be discussed in further detail below. In one embodiment, project management user interface 114 includes an input field for defining project operations data 118. As one illustrative example, in the field of arboriculture services, a project may require a variety of operations to be performed on vegetation objects. Common operations/services provided by arborists include but are not limited to, tree removal services and tree trimming services. Thus, in one embodiment, project operations data 118 may specify that the operation to be performed is tree removal. In one embodiment, project management user interface 114 includes an input field for defining project cost estimate data 120. The process for defining project cost estimate data will be discussed in further detail below. As also shown in FIG. 1C, in various embodiments, project management user interface 114 also includes operation options 186, which allow a user to add or delete project operations data 118 from project specification data 116.

In one embodiment, a map-based image (not shown) of the user’s current physical environment is provided to the user through project management user interface 114, which allows the user to add virtual representations of objects to the project, such as, but not limited to, vegetation objects. Upon adding of a vegetation object, the user may be provided with the ability to drag a representation of the object across the map to place the object within the map context.

Referring to FIGS. 1A, 1B, and 1D together, as shown in FIG. 1D, in one embodiment, project management user interface 114 includes input fields for adding dimensions data, such as vegetation dimensions data 124 to the vegetation object data 117 of project specification data 116. In one embodiment, vegetation dimensions data includes vegetation height data 124a, vegetation width data 124b, and vegetation diameter data 124c. In various embodiments, a user of the method and system disclosed herein does not know the dimensions of the vegetation object at the time the project specification data 116 is first defined and so the vegetation dimensions data 124 may be added to the project specification data 116 later in the disclosed process, as will be discussed in additional detail below.

As also shown in FIG. 1D, in one embodiment, project management user interface 114 includes an input field for adding vegetation type/species data 126 to vegetation object data 117 of project specification data 116. In one embodiment, project management user interface 114 includes input fields for adding project notes data 127, such as, but not limited to, vegetation notes 127a and crew notes 127b to project specification data 116. In various embodiments, a user of the method and system disclosed herein does not know the type/species of the vegetation object at the time the project specification data 116 is first defined and so the vegetation type/species data 126 may be added to the vegetation object data 117 of project specification data 116 later in the disclosed process, as will be discussed in additional detail below. As also shown in FIG. 1D, in various embodiments, project management user interface 114 includes vegetation object options 188, which allow a user to add or delete vegetation objects to/from vegetation object data 117 of the project specification data 116.

Returning again to FIG. 1B, in one embodiment, once the project management system has been utilized to define project specifications at operation 166, process flow proceeds to operation 168. In one embodiment, at operation 168, one or more project specifications that require vegetation analysis are identified.

Referring now to FIGS. 1A, 1B, and 1C together, in various embodiments, one important project specification related to arboriculture services projects is an estimated cost for the project. As discussed above, generating accurate and reliable project cost estimates is a time-consuming and labor-intensive process, which relies in large part on obtaining measurements of the dimensions of vegetation objects, such as trees. Thus, in one embodiment, at operation 168, project cost estimate data 120 and/or vegetation object data 117 may be identified as elements of project specification data 116 that require vegetation analysis.

Returning again to FIG. 1B, in one embodiment, once one or more project specifications that require vegetation analysis are identified at operation 168, process flow proceeds to operation 170. In one embodiment, at operation 170, the user is provided with a vegetation analysis tool through the project management system.

Referring now to FIGS. 1A and 1B together, in various embodiments, two aspects of vegetation objects that are important for determining cost estimates are vegetation dimensions and vegetation type/species. Utilizing traditional methods, as discussed above, an arboriculture service provider determines the vegetation dimensions and vegetation type/species by physically traveling to the project site and visually inspecting the site to estimate dimensions and species/type of vegetation objects, as well inspecting the site to identify other objects present on the site that may impact the overall cost of the project.

In the methods and systems disclosed herein, rather than physically traveling to the project site to perform a visual inspection, the user/service provider is able to utilize a vegetation analysis tool provided by the arboriculture services project management system 100A, such as vegetation analysis tool 140. As discussed above, in one embodiment, vegetation analysis tool 140 includes a vegetation analysis user interface 142, which includes a vegetation image collection module 144 to assist the user in collecting vegetation image data 122 for analysis. In one embodiment, vegetation image analysis module 148 of vegetation analysis tool 140 performs the vegetation analysis based on vegetation image data 122, and then the vegetation analysis tool 140 provides the user with vegetation analysis results data 150, as discussed in further detail below.

Returning again to FIG. 1B, in one embodiment, once the user is provided with the vegetation analysis tool at operation 170, process flow proceeds to operation 172. In one embodiment, at operation 172, one or more images of the vegetation to be analyzed are obtained through the vegetation analysis tool.

Referring now to FIGS. 1A and 1B together, in various embodiments, the process for obtaining images of the vegetation to be analyzed depends on the type of analysis that needs to be performed on the vegetation. In various embodiments, one or more images of the vegetation may need to be captured under specific conditions in order to perform accurate analysis. In one embodiment, the vegetation image collection module 144 of vegetation analysis tool 140 walks the user through a specific process for collecting the vegetation images based on the type of analysis to be performed. In one embodiment, the analysis to be performed relates to determining the dimensions of a vegetation object. In one embodiment, the analysis to be performed relates to determining the type/species of a vegetation object. In various other embodiments, the analysis to be performed could be any type of analysis that a user of the disclosed method and system wishes to perform on vegetation objects. In one illustrative embodiment, the vegetation object to be analyzed is a tree object, and the type of analysis to be performed relates to determining the dimensions of the tree object. The specific process for collecting the vegetation images for performing dimension analysis will be discussed in further detail below.

Returning again to FIG. 1B, in one embodiment, once one or more images of the vegetation to be analyzed are obtained at operation 172, process flow proceeds to operation 174. In one embodiment, at operation 174, the one or more images of the vegetation to be analyzed are provided to a vegetation image analysis module of the vegetation analysis tool.

In one embodiment, once the one or more images of the vegetation are provided to the vegetation image analysis module at operation 174, process flow proceeds to operation 176. In one embodiment, at operation 176, the one or more images of the vegetation to be analyzed are processed by the vegetation image analysis module to generate vegetation analysis results data.

Referring now to FIGS. 1A and 1B together, in one embodiment, the vegetation image data 122 obtained by vegetation image collection module 144 is provided to vegetation image analysis module 148 for processing and analysis. As noted above, in various embodiments, different types of analysis may be performed on vegetation objects. In one embodiment, the vegetation analysis to be performed relates to determining the dimensions of a vegetation object, and so vegetation analysis module 148 of vegetation analysis tool 140 performs a variety of specific calculations/operations in order to determine the dimensions of the vegetation object. The specific calculations/operations performed by vegetation analysis module 148 for determining the dimensions of objects, such as vegetation objects, will be discussed in further detail below. In some embodiments, vegetation image analysis module 148 may utilize vegetation database 152 to access vegetation data 154 for use in performing vegetation analysis. For example, vegetation image data may be compared to data in a repository of images and/or other data related to vegetation in order to assist with vegetation analysis.

In one embodiment, upon performing the vegetation analysis, vegetation image analysis module 148 generates vegetation analysis results data 150, which includes data related to the results of the vegetation analysis. For example, where dimensions of the vegetation object are to be determined through image analysis, the vegetation analysis results data 150 may include data such as, but not limited to, vegetation height, width, and diameter. Where vegetation type/species is to be determined through image analysis, the vegetation analysis results data 150 may include data related to the type and/or species of the vegetation.

Returning again to FIG. 1B, in one embodiment, once the vegetation analysis results data is generated at operation 176, process flow proceeds to operation 178. In one embodiment, at operation 178, the vegetation analysis results data is utilized to generate updated project specification data.

Referring again to FIGS. 1A and 1B together, in various embodiments, vegetation analysis results data 150 includes data such as, but not limited to, vegetation dimensions data 124 and vegetation type/species data 126. In one embodiment, vegetation analysis results data 150 is integrated into the vegetation object data 117 of project specification data 116. In one embodiment, the vegetation image data 122 is also integrated into the vegetation object data 117 of project specification data 116.

In one embodiment, once the vegetation analysis results data 150 and/or the vegetation image data 122 are integrated into the vegetation object data 117 of project specification data 116, a determination may be made that one or more of the project specifications represented by project specification data 116 can be updated based on the integration of vegetation analysis results data 150. As one illustrative example, as noted above, project cost estimate data 120 may have been unknown prior to performing the vegetation analysis, however once the vegetation analysis has been performed, it may be determined that enough data now exists to calculate project cost estimate data 120. In various embodiments, calculation of project cost estimate data requires use of vegetation dimensions data 124 and/or vegetation type/species data 126. Consequently, in one embodiment, vegetation dimensions data 124 and vegetation type/species data 126 is provided to estimate calculation module 128 of project management environment 112 for generation of updated project specification data, including project cost estimate data 120.

In various embodiments, project database 130 is also updated to incorporate project specification data 116 into current project data 132. In one embodiment, project database 130 also includes historical project data 134, which may be provided to AI historical project data analysis module 129 to generate additional data for use by estimate calculation module 128 in calculating project cost estimate data 120.

Returning again to FIG. 1B, in one embodiment, once updated project specification data has been generated at operation 178, process flow proceeds to operation 180. In one embodiment, at operation 180, the user is provided with the updated project specification data through the arboriculture services project management user interface.

Referring now to FIGS. 1A, 1B, and 1D together, in one embodiment, updated project specification data includes vegetation dimension data 124 as calculated by vegetation image analysis module 148 of vegetation analysis tool 140. As shown in FIG. 1D, in one embodiment, vegetation dimensions data 124 includes vegetation height data 124a, vegetation width data 124b, and vegetation diameter data 124c. In one embodiment, updated project specification data includes vegetation type/species data 126.

FIGS. 1E and 1F are screenshots 100E and 100F of an arboriculture services project management user interface, in accordance with various embodiments.

Referring to FIGS. 1A, 1E, and 1F together, FIGS. 1E and 1F show a portion of arboriculture services project management user interface 114, which provides the user with vegetation image data 122 of project specification data 116 once the project specification data has been updated after completion of the vegetation analysis. Specifically, FIGS. 1E and 1F show vegetation image data 122a through 122e being displayed to the user. In one embodiment, vegetation image data 122a through 122e are images of a vegetation object collected from the user by vegetation image collection module 144 of vegetation analysis tool 140.

As shown in FIG. 1E, in one embodiment, vegetation image data 122a is an image of a tree vegetation object captured using a single-image mode provided by vegetation image collection module 144, and vegetation image data 122b is an image of the trunk of a tree vegetation object captured using a single-image mode provided by vegetation image collection module 144.

As shown in FIG. 1F, in one embodiment, vegetation image data 122c is a horizontal panorama image of a tree vegetation object generated using a multi-image mode provided by vegetation image collection module 144, vegetation image data 122d is a vertical panorama image of a tree vegetation object generated using a multi-image mode provided by vegetation image collection module 144, and vegetation image data 122e is an image of the trunk of a tree vegetation object captured using a multi-image mode provided by vegetation image collection module 144. The differences between the single-image mode and multi-image mode provided by vegetation image collection module 144, as well as the process for generating the horizontal and vertical panorama images will be discussed in further detail below.

As also shown in FIGS. 1E and 1F, project management user interface 114 may be used to display project cost estimate data 120 to the user. While no estimated cost is currently shown in FIGS. 1E and 1F, this data may be provided to the user upon calculation of project cost estimate data 120 by estimate calculation module 128 after receipt of vegetation analysis results data 150 provided by vegetation analysis tool 140.

Returning again to FIG. 1B, in one embodiment, once the user is provided with the updated project specification data at operation 180, process flow proceeds to END operation 182 where process 100B is exited to await new project data.

As noted above, in various embodiments, vegetation analysis includes processing data associated with images of vegetation to calculate vegetation dimensions and/or vegetation type/species. In some embodiments, particularly in order to provide the user with accurate project cost estimate data, additional analysis may also need to be performed to determine location/dimensions of objects other than vegetation objects. For example, in order to accurately determine project scope and cost, additional aspects of the project site physical environment may need to be considered, including the dimensions and placement of structures and objects such as, but not limited to, gateways, overhead objects, fences, poles, buildings, and other similar structures.

In various embodiments, in order to provide the capability to measure dimensions of other types of objects in addition to vegetation objects, a user of an arboriculture services project management system is provided with a more generalized object measurement interface instead of or in addition to a vegetation analysis tool. In one embodiment, the object measurement interface can be used to measure dimensions of vegetation objects as well as dimensions of other objects, such as, but not limited to those discussed above. In some embodiment, the object measurement interface is provided to a user as a stand-alone tool which can be used as part of a larger system, such as an arboriculture services project management system, or can be used independently of any other system to measure objects that may be unrelated to arboriculture services.

In one embodiment, a user is provided with an object measurement interface through a device of a user and the object measurement interface is utilized to capture and store image data, location data, and rotation data associated with images of an object to be measured. In one embodiment, a single-image and a multi-image image capture mode is provided. In one embodiment, data identifying the edges of the object to be measured is generated through analysis of the image data and the relevant data is provided to a dimensions calculation module of the object measurement interface.

In one embodiment, the dimensions calculation module of the object measurement interface utilizes a novel combination of augmented reality (AR), photogrammetry, and sensor fusion synthesis. In one embodiment, intrinsic field of view (FOV) data and pixel density data associated with an optical component, such as a camera, of a user device are combined with distance data and pixel distance offset data obtained through analysis of images of an object to be measured to calculate the percentage of the camera’s field of view that the object occupies. In various embodiments, this combination of data allows for generation of reliable and accurate measurements using mathematical manipulation of camera optical properties.

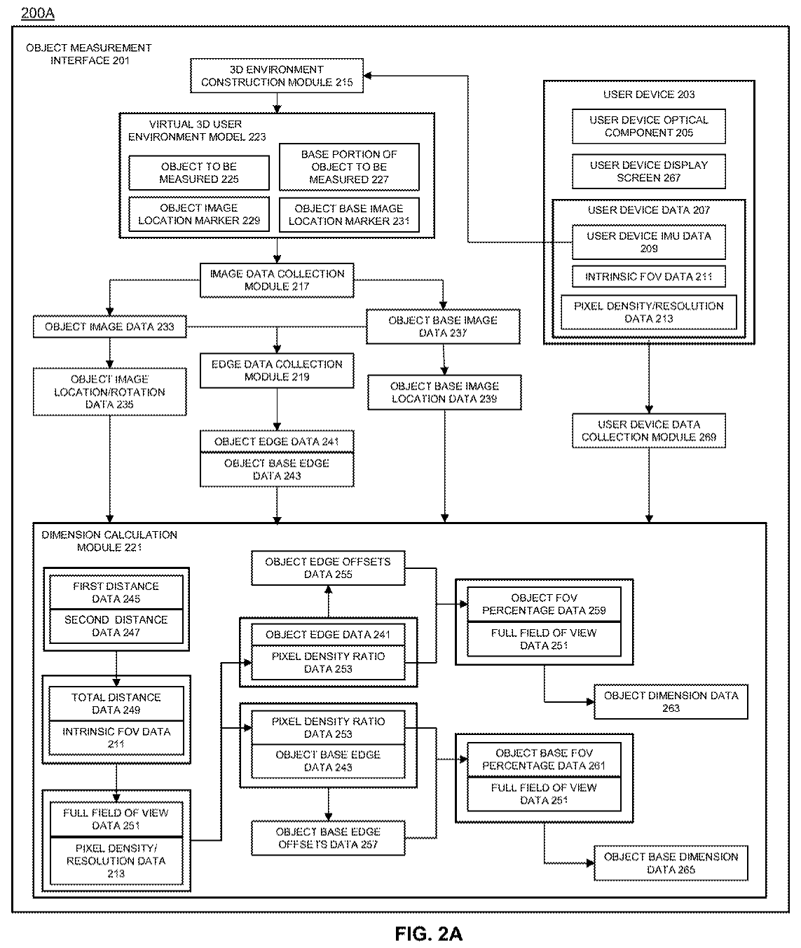

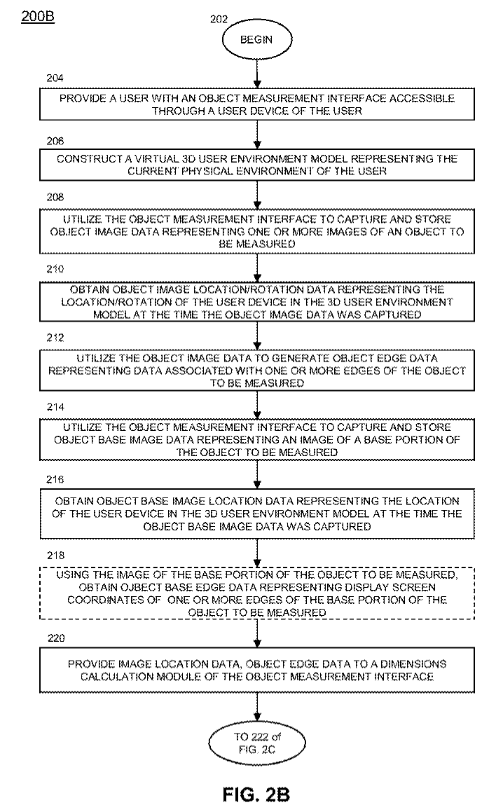

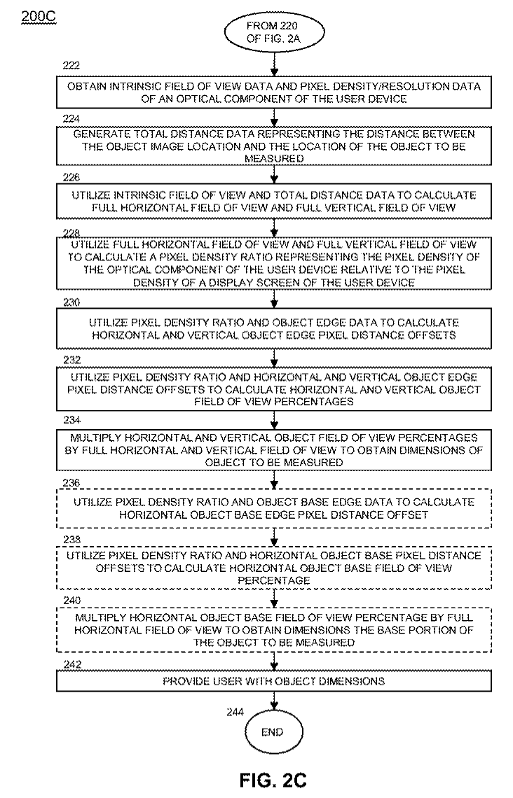

FIG. 2A is a block diagram 200A, which provides a simplified overview of an object measurement interface 201, in accordance with one embodiment.

In one embodiment, object measurement interface 201 utilizes user device 203, user device optical component 205, user device display screen 267, and user device data 207 to facilitate the object measurement process. In one embodiment, user device data 207 includes user device inertial measurement unit (IMU) data 209, intrinsic field of view (FOV) data 211, and pixel density/resolution data 213.

In one embodiment, object measurement interface 201 includes user device data collection module 269, 3D environment construction module 215, image data collection module 217, edge data collection module 219, and dimension calculation module 221.

In one embodiment, 3D environment construction module 215 is utilized to construct virtual 3D user environment model 223, which includes object to be measured 225, object image location marker 229, base portion of object to be measured 227, and object base image location marker 231, each of which will be discussed in additional detail below.

In one embodiment, image data collection module 217 enables the user to use user device optical component 205 of user device 203 to capture one or more images of object to be measured 225 and/or base portion of object to be measured 227. In one embodiment, upon the user capturing one or more images of the object to be measured 225, the image data is stored as object image data 233, and object image location marker 229 is placed in virtual 3D user environment model 223. In one embodiment, object image location marker 229 is utilized along with user device IMU data 209 to generate object image location/rotation data 235.

In one embodiment, upon the user capturing one or more images of the base portion of object to be measured 227, the base portion image data is stored as object base image data 237, and object base image location marker 231 is placed in virtual 3D user environment model 223. In one embodiment, object base image location marker 231 is utilized along with user device IMU data 209 to generate object base image location data 239.

In one embodiment, upon generation of object image data 233 and object base image data 237, edge data collection module 219 is utilized to determine image display screen coordinates of one or more edges of the object to be measured 225 and/or base portion of object to be measured 227. In one embodiment, edge data collection module 219 generates object edge data 241 representing the image display screen coordinates of one or more edges of the object to be measured 225. In one embodiment, edge data collection module 219 generates object base edge data 243 representing the image display screen coordinates of one or more edges of the base portion of object to be measured 227.

In one embodiment, once edge data collection module 219 has generated object edge data 241 and optionally object base edge data 243, object edge data 241, object base edge data 243, object image location/rotation data 235, and object base image location data 239 are provided to dimension calculation module 221 of object measurement interface 201. In one embodiment, user device data collection module 269 also provides user device data 207 to dimension calculation module 221 of object measurement interface 201.

In one embodiment, dimension calculation module 221 utilizes one or more of object image location/rotation data 235, object base image location data 239, and user device IMU data 209 to generate first distance data 245 and second distance data 247. In one embodiment, first distance data 245 represents the distance between the object image location marker 229 (i.e. the location in virtual 3D user environment model 223 that the initial image of the object was captured) and the object base image location marker 231 (i.e. the location in virtual 3D user environment model 223 that the image of the base portion of the object was captured). In one embodiment, second distance data 247 represents the distance between the object base image location marker 231 and the location of the object to be measured. In one embodiment, total distance data 249, which represents the distance between the object image location marker 229 and the object to be measured 225, is generated by calculating the sum of first distance data 245 and second distance data 247.

In one embodiment, total distance data 249 is combined with intrinsic FOV data 211 of user device data 207 to generate full field of view data 251. In one embodiment, full field of view data 251 includes full horizontal field of view data and full vertical field of view data representing the full horizontal and vertical field of view of the user device optical component 205 at the distance represented by total distance data 249.

In one embodiment, full field of view data 251 is combined with pixel density/resolution data 213 of user device data 207 to generate pixel density ratio data 253 representing the pixel density/resolution of the optical component of the user device relative to the pixel density/resolution of the display screen of the user device.

In one embodiment, pixel density ratio data 253 is combined with object edge data 241 to generate object edge offsets data 255. In one embodiment object edge offsets data 255 represents the distance in pixels that each edge of object to be measured 225 is from the corresponding edge of user device display screen 267, for example, when viewing the captured object image on user device display screen 267.

In one embodiment, pixel density ratio data 253 is combined with object edge offsets data 255 to generate object FOV percentage data 259, which represents the percentage of user device display screen 267 that is occupied by the object to be measured 225, for example, when viewing the captured object image on user device display screen 267. In one embodiment object FOV percentage data 259 is combined with the previously calculated full field of view data 251 to generate object dimensions data 263.

In one embodiment, pixel density ratio data 253 is combined with object base edge data 243 to generate object base edge offsets data 257. In one embodiment object base edge offsets data 257 represents the distance in pixels that each edge of base portion of object to be measured 227 is from the corresponding edge of user device display screen 267, for example, when viewing the captured object base image on user device display screen 267.

In one embodiment, pixel density ratio data 253 is combined with object base edge offsets data 257 to generate object base FOV percentage data 261, which represents the percentage of user device display screen 267 that is occupied by the base portion of object to be measured 227, for example, when viewing the captured object base image on user device display screen 267. In one embodiment object base FOV percentage data 261 is combined with the previously calculated full field of view data 251 to generate object base dimensions data 265.

In one embodiment, the object dimensions data 263 and/or the object base dimensions data 265 are then provided to the user, either through object measurement interface 201, or through any other user interface, such as project management user interface 114 discussed above in relation to FIG. 1A. Each of the elements discussed above in relation to FIG. 2A will be discussed in further detail below in relation to FIG. 2B.

FIG. 2B is a flowchart of a process 200B for obtaining data to calculate dimensions of an object using a specialized object measurement interface, in accordance with one embodiment.

As shown in FIG. 2B, in one embodiment, process 200B begins at BEGIN operation 202 and then process flow proceeds to operation 204. In one embodiment, at operation 204, a user is provided with an object measurement interface accessible through a device of the user.

In various embodiments, the device of the user is a mobile device, such as, but not limited to, a mobile phone. In one embodiment, the user device includes a user device optical component. In one embodiment, user device optical component is a camera. In one embodiment, the user device also includes a user device display screen.

As noted above, in some embodiments, the object measurement interface is provided as part of a larger system, such as, but not limited, an arboriculture services project management system, which may also be accessible through the user device.

As one illustrative example, in one embodiment, a user is a provider of arboriculture services and needs to determine an estimated cost for a tree removal services project. In order to determine an estimated cost for a tree removal services project, the dimensions of the tree to be removed need to be determined. In one embodiment, the user of a system, such as, but not limited to, an arboriculture services project management system, is provided with an option to initiate a measurement of a tree object.

Referring again briefly to FIG. 1C, FIG. 1C is a screenshot 100C of an object measurement initiation portion of an arboriculture services project management system, in accordance with one embodiment.

As discussed above, in one embodiment, an arboriculture services project management system includes project management user interface 114, which allows the user to provide, obtain, and store data related to a variety of objects/operations associated with an arboriculture services project. In the illustrative example of FIG. 1C, in order to initiate measurement of an object, such as a tree, the user is provided with “Take Measured Picture” image option 184b. In one embodiment, upon choosing the “Take Measured Picture” image option 184b, the user is redirected to a native object measurement interface, which may be installed on a device of the user. In one embodiment, if the native object measurement interface is not installed, the user is prompted to download and install the object measurement interface before proceeding.

As noted above, while in the illustrative example of FIG. 1C, the object measurement interface is provided as part of a larger arboriculture project management system, in many embodiments, the object measurement interface is provided as a stand-alone tool that can be utilized outside of any larger project management system. As such, while the illustrative embodiments shown and discussed herein depict utilizing the object measurement interface to measure dimensions of a tree for the purposes of generating more accurate and reliable project cost estimates, it should be appreciated that the object measurement interface disclosed herein can also be used for measurement of a wide variety of other objects.

Referring again to FIG. 2B, in one embodiment, once the user is provided with an object measurement interface at operation 204, process flow proceeds to operation 206. In one embodiment, at operation 206, a virtual 3D user environment model is constructed representing the current physical environment of the user.

In one embodiment, once the object measurement interface is launched, a 3D environment construction module of the object measurement interface is utilized to a construct virtual 3D user environment model. In various embodiments, the virtual 3D model of the user’s environment is constructed utilizing feature analysis and depth mapping to perceive the features of the user’s environment, and sensor fusion from the device’s inertial measurement unit (IMU) to determine the motion of the user device over time. In one embodiment, the virtual 3D user environment model is constructed by utilizing a publicly available mobile augmented reality (AR) library, such as, but not limited to ARCore and ARKit. In one embodiment, the mobile AR library is a proprietary library developed by the inventors. In various embodiments, construction of the virtual 3D user environment model only takes a few seconds to complete.

In one embodiment, once the virtual 3D user environment model is constructed at operation 206, process flow proceeds to operation 208. In one embodiment, at operation 208, the object measurement interface is utilized to capture and store object image data representing one or more images of an object to be measured.

In various embodiments once the virtual 3D user environment model is constructed, the user is guided through a step-by-step process for measurement of the desired object. As noted above, in one embodiment, the object measurement interface provides the user with two modes for object measurement, single-image mode, and multi-image mode. In various embodiments, the user may select between single-image mode and multi-image mode through the interface prior to collecting the object images.

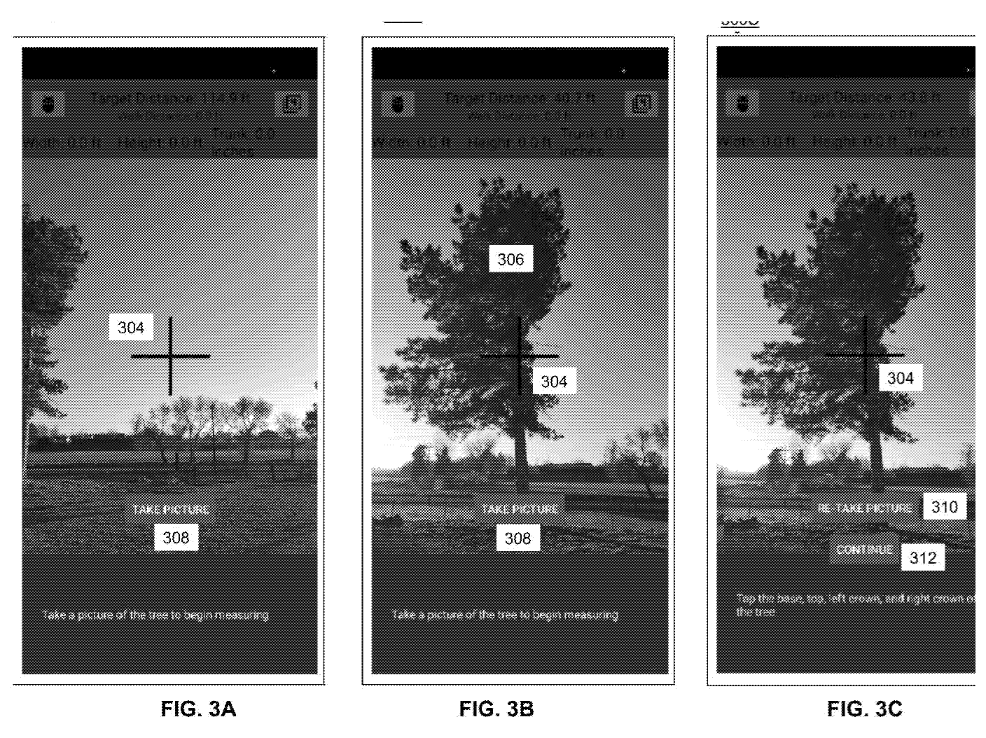

FIGS. 3A-3C are screenshots 300A through 300C of an image capture portion of an object measurement interface using single-image mode, in accordance with one embodiment.

As shown in FIG. 3A, in one embodiment, upon selection of single-image mode, the object measurement interface launches a live camera mode of the user device and presents the user with crosshairs 304 along with instructions to take a picture of the object to begin measuring. In the illustrative embodiments discussed herein, the object to be measured is a tree, however as noted above, the object measurement interface disclosed herein is capable of performing measurements on a wide variety of other objects. FIG. 3B shows the crosshairs 304 being positioned by the user over the object to be measured, which in this illustrative example, is shown as tree 306. Once the crosshairs 304 have been positioned over the object to be measured, the user may press a button, such as take picture button 308, to capture an image of the object, such as tree 306. In one embodiment, once the user has captured the image of the object, the image freezes on the display screen of the user’s device to allow the user to review the image before continuing. In one embodiment, if the user finds the image to be unsatisfactory, the user may press retake picture button 310 to capture a new image, as shown in FIG. 3C. As also shown in FIG. 3C, in one embodiment, if the user finds the image to be satisfactory, the user may press continue button 312 to continue with the measurement process.

As noted above, in some embodiments, the user may wish to utilize the multi-image mode of the object user interface instead of the single-image mode. For example, in some situations, the user may be unable to fit the entire object in the camera frame due to a variety of environmental constraints. For example, if the object to be measured is located in a confined or tight space, or if the object is too wide, such that it exceeds a single-frame capture, then accurate measurement of the object may not be able to be performed using single-image mode.

In various embodiments some of the steps for displaying and saving data and some of the calculation operations are the same in multi-image mode as in single-image mode, however the overall process for the two modes differs in some fundamental respects. As one specific example, while the process for constructing the virtual 3D user environment performed in operation 206 is the same regardless of which mode is utilized, as the mode name implies, single-image image mode requires initially capturing one image of the object to be measured for analysis, while multi-image mode requires initially capturing more than one image of the object to be measured for analysis.

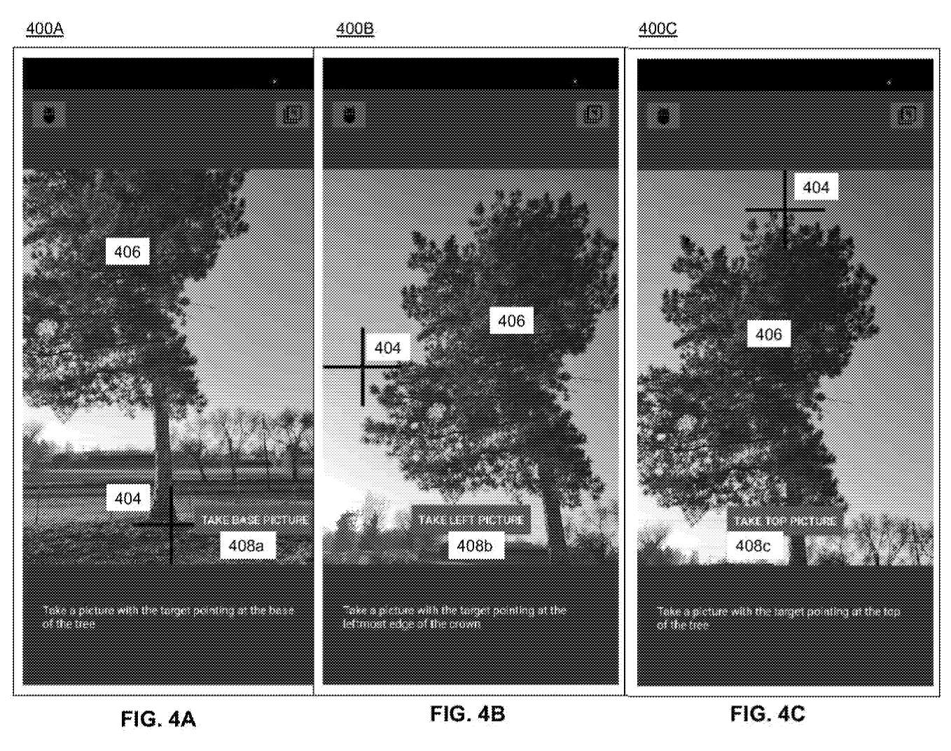

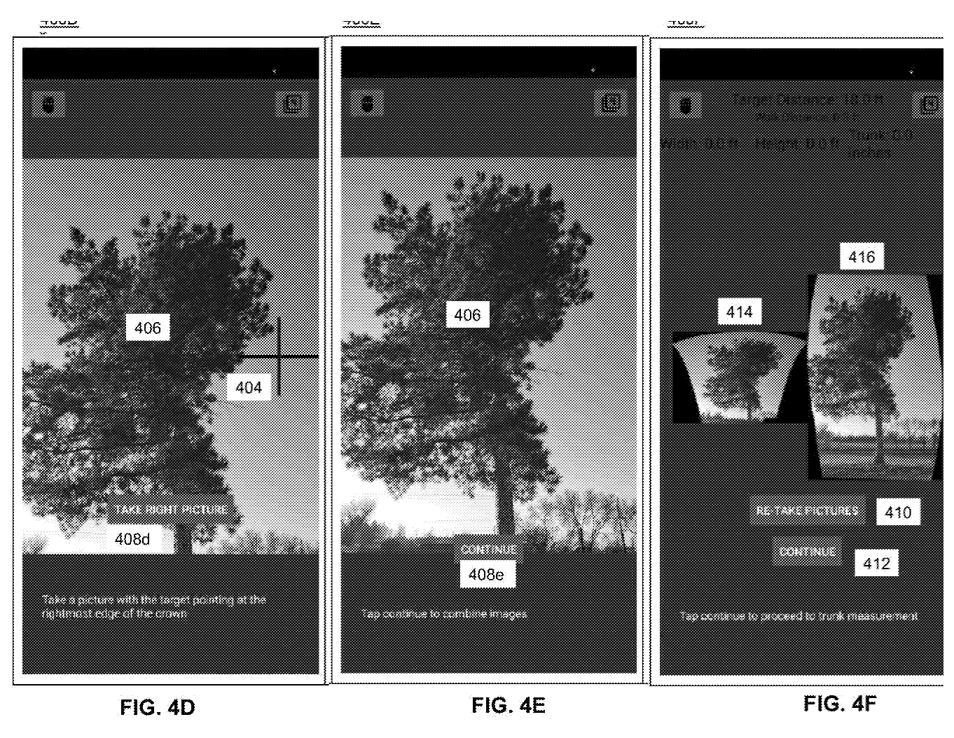

FIGS. 4A-4F are screenshots 400A through 400F of an image capture portion of an object measurement interface using multi-image mode, in accordance with one embodiment.

In one embodiment, upon initiation of multi-image mode, the object measurement interface presents the user with crosshairs 404 along with instructions to point crosshairs 404 at the base/bottom of the object to be measured. In the illustrative embodiment of FIGS. 4A-4D, the object to be measured is shown as tree 406. In one embodiment, once the user has positioned crosshairs 404 as instructed, the user may press a button, such as take base picture button 408a, to capture an image of the base/bottom of the object, as shown in FIG. 4A.

As shown in FIG. 4B, in one embodiment, once the user captures the base/bottom image, the object measurement interface automatically shifts crosshairs 404 upward and to the left of the user device display screen, and the user is instructed to point crosshairs 404 at a leftmost portion of the object, such as the leftmost crown edge of tree 406. In one embodiment, once the user has positioned crosshairs 404 as instructed, the user may press a button, such as take left picture button 408b, to capture an image of the leftmost portion of the object.

As shown in FIG. 4C, in one embodiment, once the user captures the image of the leftmost portion of the object, the object measurement interface automatically shifts crosshairs 404 to the top center of the user device display screen, and the user is instructed to point crosshairs 404 at a topmost portion of the object, such as the top of tree 406. In one embodiment, once the user has positioned crosshairs 404 as instructed, the user may press a button, such as take top picture button 408c, to capture an image of the topmost portion of the object.

As shown in FIG. 4D, in one embodiment, once the user captures the image of the topmost portion of the object, the object measurement interface automatically shifts crosshairs 404 downwards and to the right of the user device display screen, and the user is instructed to point crosshairs 404 at a rightmost portion of the object, such as the rightmost crown edge of tree 406. In one embodiment, once the user has positioned crosshairs 404 as instructed, the user may press a button, such as take right picture button 408d, to capture an image of the rightmost portion of the object.

As shown in FIG. 4E, in one embodiment, once the bottom, left, top, and right images of the object have been captured, the user may be presented with continue button 408e, which allows the user to continue with the measurement process. In one embodiment, in multi-image mode, prior to continuing with the measurement process, two or more of the captured images may be combined for displaying to the user.

As shown in FIG. 4F, in one embodiment, the image of the leftmost portion of the object, as illustrated in FIG. 4B, and the image of the rightmost portion of the object, as illustrated in FIG. 4D, are combined to generate horizontal panoramic image 414. In one embodiment, the image of the base/bottom portion of the object, as illustrated in FIG. 4A, and the image of the topmost portion of the object, as illustrated in FIG. 4C, are combined to generate vertical panoramic image 416. In various embodiments, the generation of horizontal panoramic image 414 and vertical panoramic image 416 is not a required portion of the measurement process and is simply provided to enhance the user experience. As such, specifics of the process for utilizing the captured images to generate panoramic images will be discussed in a later portion of the present disclosure.

Referring back to FIG. 2B, as noted above, in various embodiments, a user may choose single-image measurement mode or multi-image measurement mode to proceed with object measurement. In one embodiment, upon selection of single-image mode, a single image of the object to be measured is captured at operation 208, and object image data representing the single image is stored for later use in object measurement calculations. In one embodiment, upon selection of multi-image mode, multiple images of the object to be measured are captured at operation 208, and object image data representing the multiple images is stored for later use in object measurement calculations.

In one embodiment, once object image data is captured and stored at operation 208, process flow proceeds to operation 210. In one embodiment, at operation 210, object image location/rotation data is obtained representing the location/rotation of the user device in the virtual 3D user environment model at the time the object image data was captured.

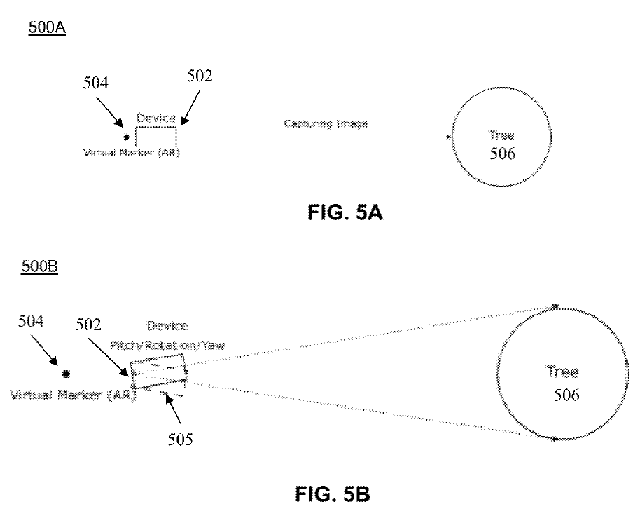

FIGS. 5A and 5B are diagrams 500A and 500B of a user capturing an image of an object in accordance with various embodiments.

Specifically, FIG. 5A is a diagram of a user device 502 capturing an image of an object, such as tree 506, including setting of virtual object image location marker 504, which represents the location of the user device in the virtual 3D user environment model at the time the object image data was captured. In various embodiments, object image location data is obtained using the IMU of the user device in both single-image and multi-image mode.

FIG. 5B is a diagram of a user device 502 capturing an image of an object, such as tree 506, including setting of virtual object image location marker 504, which represents the location of the user device in the virtual 3D user environment model at the time the object image data was captured. Also shown in FIG. 5B is user device rotation data 505. In various embodiments, when the user selects multi-image mode, user device rotation data 505 is obtained in addition to the object image location data represented by virtual object image location marker 504.

For example, as discussed above, in multi-image mode, multiple images of the object to be measured are captured, with the user needing to rotate the user device to capture the different portions of the object to be measured. As the user rotates the device, the camera will be tilted, thus the camera’s field of view will be shifted during the multi-image capturing process.

Generally speaking, all modern devices have a built-in sensor suite, which is part of its inertial measurement unit (IMU). This built-in sensor suite typically includes a gravitometer and accelerometer, which allows for a determination of where the user device is in relationship to the earth’s magnetic field, where the user device is in relationship to gravity, and where the user device is in relationship to a user’s acceleration (i.e. how the user is being accelerated).

In one embodiment, for each image captured in multi-image mode, the user device’s IMU data is utilized to calculate the user device’s rotation as a quaternion. The quaternion is then applied to a standardized vector to produce a relative unit vector. In one embodiment, data representing the rotation quaternion and the resulting relative unit vector is stored along with the object image data as object image rotation data for use in later object measurement calculations.

Referring back to FIG. 2B, in one embodiment, once object image location/rotation data is obtained at operation 210, process flow proceeds to operation 212. In one embodiment, at operation 212, the object image data is utilized to generate object edge data representing data associated with one or more edges of the object to be measured.

In various embodiments, whether single-image mode or multi-image mode is selected, the object image data is utilized to generate object edge data representing data associated with the edges of the object, which will be stored for use in later object measurement calculations. In various embodiments, the process for generating the object edge data differs depending on whether single-image mode or multi-image mode has been selected.

In one embodiment, in single-image mode, the image of the object to be measured, which was captured by the user in operation 208, is displayed to the user on the display screen of the user device, and the user is prompted to utilize features of the object measurement interface to mark key object measurement points, such as object edges.

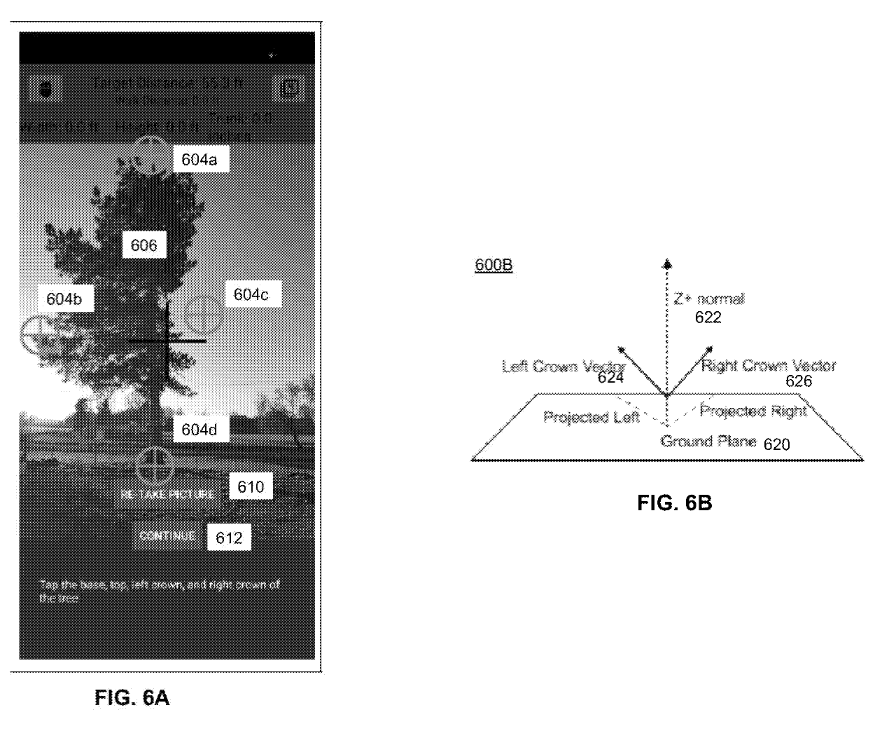

FIG. 6A is a screenshot 600A of an object edge marking portion of an object measurement interface using single-image mode, in accordance with one embodiment.

As shown in FIG. 6A, in one embodiment, the object measurement interface prompts the user to mark key points of the object using crosshairs 604a, 604b, 604c, and 604d. In various embodiments, the user may place object measurement markers, such as crosshairs 604a, 604b, 604c, and 604d, based on the characteristics of the object to be measured. For instance, in the illustrative example of FIG. 6A, placement of crosshairs 604a at the top edge of tree 606 and placement of crosshairs 604d at the bottom edge of tree 606 allows for measurement of the height of tree 606, while placement of crosshairs 604b at the left edge of tree 606 and placement of crosshairs 604c at the right edge of tree 606 allows for measurement of the width of tree 606.

In one embodiment, the user places crosshairs 604a, 604b, 604c, and 604d by tapping on the screen, and the crosshairs can be dragged and adjusted for precision. In various embodiments, the user may add crosshairs to the user device display screen according to their measurement needs. For instance, the user may choose to measure only object height, only object width, or both height and width, and the crosshairs for marking edges of the object may be added to the user device display screen accordingly.

In one embodiment, once the edge markers, represented by crosshairs 604a, 604b, 604c, and 604d, have been placed by the user, the screen coordinates of the placed markers are recorded as object edge data for use in later object measurement calculations. In some embodiments, instead of the user manually marking the object edges by placing crosshairs, computer vision and AI enhanced object detection functions are utilized to automatically perform the identification of the tree edges.

In multi-image mode, the process for generating object edge data involves utilizing the captured object images, along with the associated image location and rotation data to calculate total horizontal deflection of the device between the leftmost and rightmost images and total vertical deflection of the user device between the bottom and topmost images.

FIG. 6B is a diagram 600B showing the process for generating object edge data in multi-image mode, in accordance with one embodiment. Specifically, in order to determine the horizontal edges of the object in multi-image mode, the plane of the ground, shown in FIG. 6B as ground plane 620, is first identified using its Z positive normal vector 622. In one embodiment, Z positive normal vector 622 is determined by the accelerometer of the user device.

Referring now to FIGS. 4A-4D and 6B together, in one embodiment, the display screen coordinates of crosshairs 404 shown in the image of the leftmost portion of tree 406 (FIG. 4B), along with the stored object image location/rotation data are utilized to generate a left-side object measurement vector, which is shown in FIG. 6B as left crown vector 624. In one embodiment, the display screen coordinates of crosshairs 404 shown in the image of the rightmost portion of tree 406 (FIG. 4D), along with the stored object image location/rotation data are utilized to generate a right-side object measurement vector, which is shown in FIG. 6B as right crown vector 626. In one embodiment, left crown vector 624 and right crown vector 626 are then projected onto ground plane 620 to calculate the total degrees of horizontal deflection of the user device between the leftmost and rightmost images.

In one embodiment, the total vertical deflection is calculated similarly to the horizontal deflection. For example, display screen coordinates of crosshairs 404 shown in the image of the bottom portion of tree 406 (FIG. 4A), along with the associated stored object image location/rotation data are utilized to generate a bottom object measurement vector. Display screen coordinates of crosshairs 404 shown in the image of the top portion of tree 406 (FIG. 4C), along with the associated stored object image location/rotation data are utilized to generate a top object measurement vector. To calculate vertical deflection, a parallel plane is generated by taking the cross-product Z positive normal vector and the bottom object measurement vector. The top and bottom object measurement vectors are then projected into the parallel plane to calculate the total degrees of vertical deflection of the user device between the bottom and topmost images.

As discussed above, in one embodiment, in single-image mode, object edge data is generated by having the user place visual markers over the object image, and the display screen coordinates of the markers are stored as object edge data for use in the object measurement calculations.

As also discussed above, in one embodiment, in multi-image mode, total degrees of horizontal and vertical deflection of the user device between the multiple captured images is calculated, and this deflection data is stored as object edge data for use in the object measurement calculations.

Referring back to FIG. 2B, in one embodiment, once object edge data is generated at operation 212, process flow proceeds to operation 214. In one embodiment, at operation 214, the object measurement interface is utilized to capture and store object base image data representing an image of a base portion of the object to be measured.

In various embodiments, whether the user is in single-image or multi-image mode, the next step in the process for obtaining data to calculate dimensions of the object requires object localization. In the disclosed embodiments, in order to perform object localization, the user is instructed through the object measurement interface to move closer to the object to be measured and capture an image of a base portion of the object to be measured. In the illustrative embodiment discussed herein where the object to be measured is a tree, a base portion of the objected to be measured would be the trunk portion of the tree.

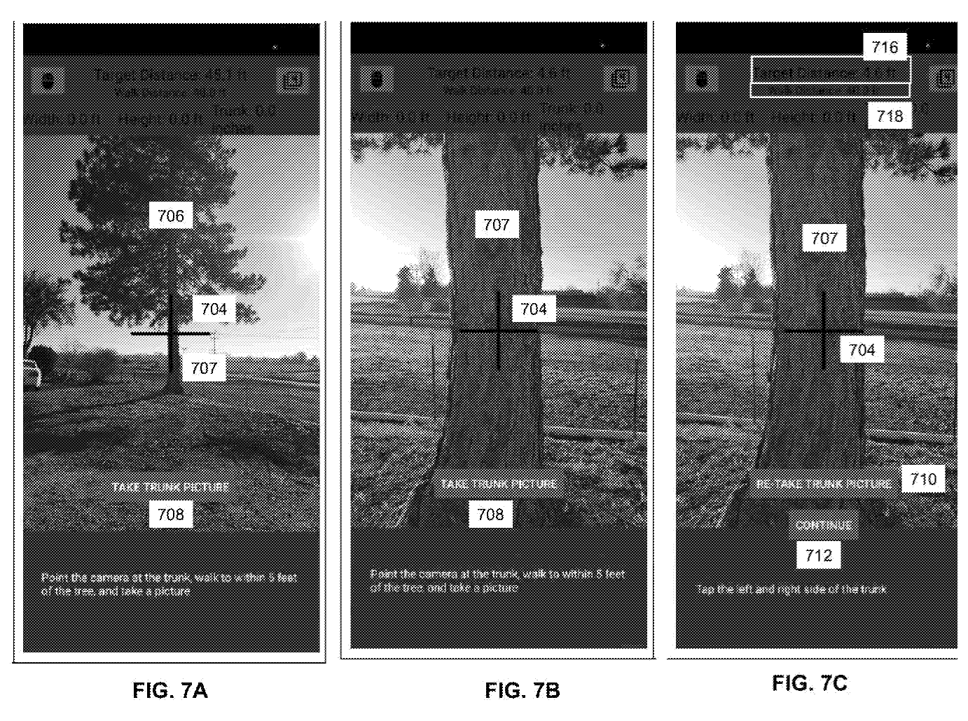

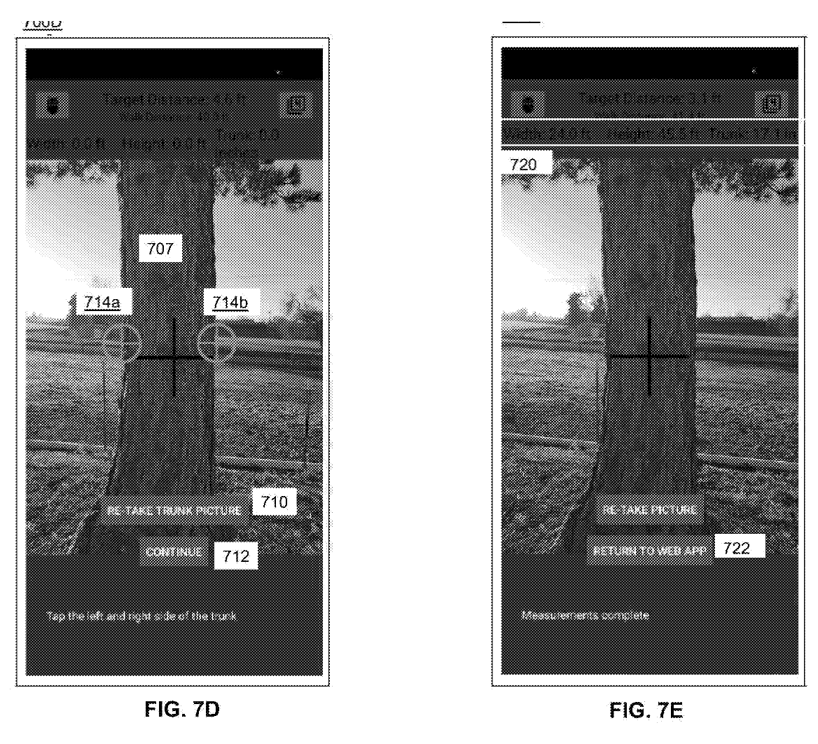

FIGS. 7A-7C are screenshots 700A through 700C illustrating portions of the object localization process, in accordance with various embodiments.

In one embodiment, once object edge data has been generated, the object measurement interface returns the display screen of the user device to a live camera mode, and the user is instructed to aim the device’s camera at a base portion of the object to be measured. For example, as shown in FIG. 7A, crosshairs 704 are being pointed at trunk portion 707 of tree 706. In one embodiment, the user is then instructed to move within approximately 5 feet of the object. In the case of the user measuring a tree, such as tree 706, the user would walk towards tree 706 with the device’s camera pointed at trunk portion 707 of tree 706, as shown in FIG. 7B. In one embodiment, once the user is within approximately 5 feet of the tree, the user may select take trunk picture button 708 to capture an image of the base portion of the object to be measured. In one embodiment, once the user has captured the image of the base portion of the object, the image freezes on the display screen of the user’s device to allow the user to review the image before continuing. In one embodiment, if the user finds the image to be unsatisfactory, the user may press retake trunk picture button 710 to capture a new image, as shown in FIG. 7C. As also shown in FIG. 7C, in one embodiment, if the user finds the image to be satisfactory, the user may press continue button 712 to continue with the measurement process. In one embodiment, once the user is within approximately 5 feet of the object to be measured, the object measurement interface will automatically take an image of the base portion of the object. In one embodiment, object base image data representing the image of the base portion of the object is stored for use in the object measurement calculations.

Returning again to FIG. 2B, in one embodiment, once object base image data is captured and stored at operation 214, process flow proceeds to operation 216. In one embodiment, at operation 216, object base image location data is obtained representing the location of the user device in the virtual 3D user environment model at the time the object base image data was captured.

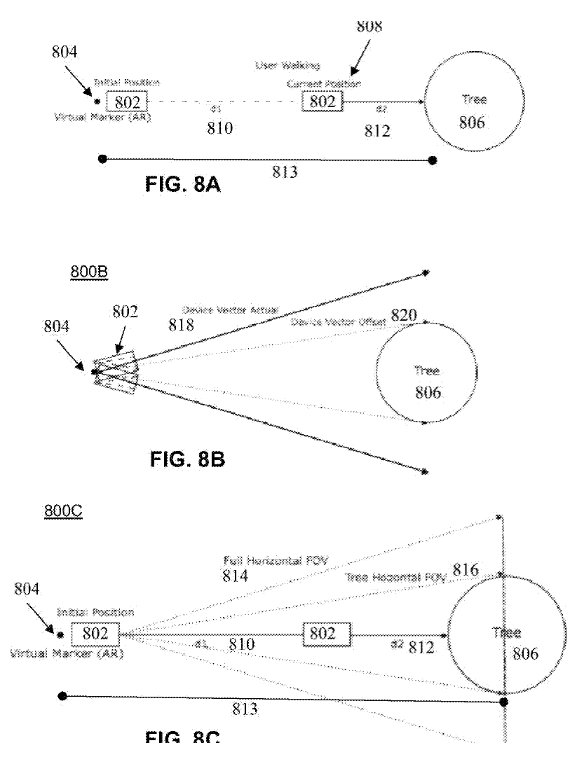

FIG. 8A is a diagram 800A illustrating a portion of the object localization process, in accordance with one embodiment.

As shown in FIG. 8A, in one embodiment, as the user walks towards tree 806 with a camera of device 802 pointed at the trunk of tree 806, depth mapping data is utilized to continuously update a first distance 810, which is the estimated distance that the device has moved relative to its initial position (represented in FIG. 8A by virtual image location marker 804). In one embodiment, as the user walks towards tree 806 with a camera of device 802 pointed at the trunk of tree 806, depth mapping data is also utilized to continually update a second distance 812, which is the estimated distance that the user is from the trunk of the tree. In one embodiment, when the user captures the image of the trunk of tree 806, a virtual object base image location marker 808 is set, which represents the location of the user device in the virtual 3D user environment model at the time the object base image data was captured. In various embodiments, object base image location data is obtained using the IMU of the user device in both single-image and multi-image mode.

Referring now to and FIGS. 8A and 7C together, as noted above, in one embodiment, first distance 810 and second distance 812 are continually updated and displayed to the user as the user walks closer to the object to be measured. In one embodiment, an information display portion of the object measurement interface device displays the first distance 810 (i.e. the distance that the user has walked from the user’s initial position), as shown by walking distance display area 718. In one embodiment, an information display portion of the object measurement interface also displays the second distance 812 (i.e. the distance that the user currently is from the object to be measured) to the user, as shown by target distance display area 716.

Referring back to FIG. 2B, in one embodiment, once object base image location data is obtained at operation 216, process flow proceeds to operation 218. In one embodiment, at operation 218, the image of the base portion of the object to be measured is utilized to obtain object base edge data representing display screen coordinates of one or more edges of the base portion of the object to be measured.

In one embodiment, once an acceptable image of the base portion of the object to be measured has been captured and the object base image location data has been obtained, the user is given the option to perform measurement calculations on the base of the object as well as on the object itself. For example, in the case where the object to be measured is a tree, the user may wish to perform a diameter measurement on the trunk of the tree. In one embodiment, if the user does not wish to perform a measurement on the base portion of the object, the user may choose to continue without providing object base edge data, and process flow proceeds to operation 220.

In one embodiment, if the user does wish to perform a measurement on the base portion of the object, the object measurement interface prompts the user to mark key points of the object base.

FIG. 7D is a screenshot 700D of an object base edge marking portion of an object measurement interface using either single-image mode or multi-image mode, in accordance with one embodiment.

As shown in FIG. 7D, in one embodiment, the object measurement interface prompts the user to mark key points of the object using crosshairs 714a and 714b. In various embodiments, the user may place object base measurement markers, such as crosshairs 714a and 714b, based on the characteristics of the object to be measured. For instance, in the illustrative example of FIG. 7D, placement of crosshairs 714a at the left edge of tree trunk 707 and placement of crosshairs 714b at the right edge of tree trunk 707 allows for measurement of the width and/or diameter of tree trunk 707. In one embodiment, the user places crosshairs 714a and 714b by tapping on the user device display screen, and the crosshairs 714a and 714b can be dragged and adjusted for precision.

In one embodiment, once the base edge markers, represented by crosshairs 714a and 714b, have been placed by the user, the screen coordinates of the placed markers are recorded as object base edge data for use in later object measurement calculations. In some embodiments, instead of the user manually marking the object base edges by placing crosshairs, computer vision and AI enhanced object detection functions are utilized to automatically perform the identification of the object base edges. In various embodiments, once the user has finished placing the base edge markers, the user may press continue button 712 to proceed with the object measurement calculations.

In one embodiment, once object base edge data is optionally obtained at operation 218, process flow proceeds to operation 220. In one embodiment, at operation 220, the image location data, the object edge data, and optionally, the object base edge data, are provided to a dimension's calculation module of the object measurement interface.

In one embodiment, whether the user is in single-image mode or multi-image mode, the previously captured image location data is provided to the dimensions calculation module of the object measurement interface. Specifically, in one embodiment, the object image location data representing the location of the user device in the 3D user environment model at the time the object image data was captured is provided to the dimensions calculation module. In one embodiment, the object base image location data representing the location of the user device in the 3D user environment model at the time the object base image data was captured is provided to the dimensions calculation module. In one embodiment, if the user is in multi-image mode, the object image rotation data representing the rotation of the user device in the 3D environment at the time each of the multiple images was captured is also provided to the dimensions calculation module.

In one embodiment, the obtained object edge data is also provided to the dimensions calculation module. For example, in one embodiment, if the user is in single-image mode, the object edge data generated at operation 212 may include screen coordinates for the top, bottom, left, and right edges of the object. In one embodiment, if the user is in multi-image mode, the object edge data generated at operation 212 may include deflection data representing the total degrees of horizontal and vertical deflection of the user device between the multiple captured images. Further, in one embodiment, if the user decided to provide object base edge data at operation 218, for example, to perform a width/diameter measurement of the base portion of the object, then the object base edge data is also provided to the dimensions calculation module at operation 220.

In one embodiment, once the image location data and the object edge data are provided to a dimensions calculation module of the object measurement interface at operation 220, process flow proceeds to operation 222 of FIG. 2C.

FIG. 2C is a flowchart of a process 200C for calculating object dimensions using a dimensions calculation module of the object measurement interface, in accordance with one embodiment.

As seen in FIG. 2C, in one embodiment, process 200C receives the image location data, the object edge data, and the object base edge data from operation 220 of process 200B of FIG. 2B and then process flow proceeds to operation 222.

In one embodiment, at operation 222, intrinsic field of view data and pixel density data of an optical component of the user device is obtained.

In one embodiment, in order to perform the dimensions calculation, a user device data acquisition module of the object measurement interface obtains user device data, including, but not limited to, intrinsic field of view data and pixel density data. Generally speaking, intrinsic field of view refers to the area of a scene that a camera is able to capture based on its internal parameters, such as focal length and sensor size, typically expressed in degrees. Pixel density of a camera refers to the number of pixels packed into a given area of a camera’s sensor, typically measured in pixels per inch (PPI). In one embodiment, data representing intrinsic field of view and pixel density of an optical component of the user’s device is obtained by utilizing platform-specific APIs or libraries to access the user device data.

In one embodiment, once intrinsic field of view data and pixel density data is obtained at operation 222, process flow proceeds to operation 224.

In one embodiment, at operation 224, total distance data is generated representing the distance between the object image location and the location of the object to be measured.

Referring again to FIG. 8A, the first distance 810, which is the estimated distance that the device has moved relative to its initial position (represented in FIG. 8A by virtual image location marker 804), and the second distance 812, which is the estimated distance between the virtual object base image location marker 808 (i.e. the location of the user device in the virtual 3D user environment model at the time the object base image data was captured) and the object to be measured, such as tree object 806, are added together to get the total distance 813 from the initial object image location to the location of the object to be measured.

Returning again to FIG. 2C, in one embodiment, once total distance data is generated at operation 224, process flow proceeds to operation 226. In one embodiment, at operation 226, the intrinsic field of view data and the total distance data are utilized to calculate full horizontal field of view and full vertical field of view.

In one embodiment, optics and trigonometry are utilized along with the intrinsic field of view data to calculate the camera’s full horizontal and full vertical field of view at the distance represented by the total distance data.

In one embodiment, once full horizontal field of view and full vertical field of view are calculated at operation 226, process flow proceeds to operation 228.

In one embodiment, at operation 228, the data representing the full horizontal and full vertical field of view is utilized to calculate a pixel density ratio representing the pixel density/resolution of the optical component of the user device relative to the pixel density/resolution of the display screen of the user device. In one embodiment, calculation of pixel density ratio allows a determination to be made as to how large each pixel of an image is at a given distance.

In one embodiment, once the pixel density ratio is calculated at operation 228, process flow proceeds to operation 230. In one embodiment, at operation 230, the pixel density ratio and the object edge data are utilized to calculate horizontal and vertical object edge pixel distance offsets.

As discussed above, in one embodiment, in single-image mode, object edge data has been recorded as four sets of screen coordinates, which represent the top, bottom, left, and right edges of the object to be measured. In one embodiment, the pixel density ratio and the distance between the screen coordinates for the left and right edges of the object to be measured are utilized to calculate horizontal object edge pixel distance offset, and the pixel density ratio and the distance between the screen coordinates for the top and bottom edges of the object to be measured are utilized to calculate vertical object edge pixel distance offset.

As also discussed above, in one embodiment, in multi-image mode, object edge data was stored in terms of the total degrees of horizontal and vertical deflection of the user device between the multiple captured images. In various embodiments, the data representing the horizontal deflection is utilized to calculate horizontal object edge pixel distance offset, and the data representing the vertical deflection is utilized to calculate vertical object edge pixel distance offset. In one embodiment, calculation of horizontal and vertical object edge pixel distance offsets allows for construction of a virtual field of view for use in calculation of object dimensions.

FIG. 8B is a diagram 800B illustrating calculation of device vector offset 820 relative to device vector actual 818 in multi-image mode, in accordance with one embodiment.

In one embodiment, once horizontal and vertical object edge pixel distance offsets are calculated at operation 230, process flow proceeds to operation 232.

In one embodiment, at operation 232, the pixel density ratio and the horizontal and vertical object edge pixel distance offsets are utilized to calculate horizontal and vertical object field of view percentages. In various embodiments, whether in single-image or multi-image mode, the pixel density ratio calculated at operation 228 and the horizontal and vertical object edge pixel distance offsets calculated at operation 230 are utilized to calculate horizontal and vertical object field of view percentages, which represent the percentage of the full horizontal and vertical fields of view that the object occupies. As discussed above, in one embodiment, in multi-image mode, the object edge pixel distance offsets are utilized to construct a virtual field of view, which is then utilized to calculate the horizontal and vertical object field of view percentages.

FIG. 8C is a diagram 800C illustrating a top-down view of a portion of the process for determining horizontal object field of view percentages, in accordance with one embodiment. The process for determining vertical object field of view percentages (not shown) may be similarly illustrated utilizing a side view diagram.

As shown in FIG. 8C, full horizontal field of view 814 represents the total area or angular extent that a camera, such as a camera of user device 802, can capture, and is typically measured in degrees. Tree horizontal FOV 816 represents the portion of full horizontal FOV 814 that tree 806 is taking up at the particular distance represented by total distance data 813. Consequently, the pixel density ratio and the horizontal object edge pixel distance offsets can be utilized to calculate a horizontal object field of view percentage, which represents the percentage of the full horizontal field of view 814 that tree 806 is taking up at the particular distance represented by total distance data 813. Likewise, the pixel density ratio and the vertical object edge pixel distance offsets can be utilized to calculate a vertical object field of view percentage, which represents the percentage of the full vertical field of view that tree 806 is taking up at the particular distance represented by total distance data 813.

In one embodiment, once the horizontal and vertical object field of view percentages are calculated at operation 232, process flow proceeds to operation 234. In one embodiment, at operation 234, the horizontal and vertical field of view percentages calculated at operation 222 are multiplied by the full horizontal and full vertical field of view calculated at operation 226 to obtain the dimensions of the object to be measured.

In one embodiment, once the dimensions of the object to be measured are calculated at operation 234, if the user wishes to have the dimensions of the base portion of the object calculated as well as the dimensions of the full object, process flow proceeds to operation 236. In one embodiment, once the dimensions of the object to be measured are calculated at operation 234, if the user does not wish to have the dimensions of the base portion of the object calculated as well as the dimensions of the full object, process flow proceeds to operation 242, which will be discussed in further detail below.

In one embodiment, at operation 236, if the user wishes to calculate the dimensions of the base portion of the object, the pixel density ratio and the object base edge data is utilized to calculate a horizontal object base pixel distance offset.

As discussed above in relation to FIG. 2B, at operation 218, the user was given the option to provide object base edge data for calculating the dimensions of the base of the object. Whether the user is in single-image mode or multi-image mode, the process for calculating the dimensions of the object base is the same. Further, in various embodiments, the object base dimensions are calculated using the same process described above of combining distance, field of view, and edge markers. In various embodiments, the object base only has a horizontal component, so the object base is only calculated in that dimension.

As discussed above, in one embodiment, when provided by the user, object base edge data is recorded as two sets of screen coordinates which represent the left and right edges of the base portion of the object to be measured. In one embodiment, the screen coordinates for the left and right edges of the base portion of the object to be measured are utilized in conjunction with the pixel density ratio to calculate horizontal object base edge pixel distance offset.

In one embodiment, once the horizontal object base edge pixel distance offset is calculated at operation 236, process flow proceeds to operation 238. In one embodiment, at operation 238, the pixel density ratio and the horizontal object base edge pixel distance offset are utilized to calculate horizontal object base field of view percentage.

In various embodiments, whether in single-image or multi-image mode, the pixel density ratio calculated at operation 228 and the horizontal object base edge pixel distance offset calculated at operation 236 are utilized to calculate a horizontal object base field of view percentage, which represents the percentage of the full field of view that the base portion of the object occupies.

In one embodiment, once the horizontal object base field of view percentage is calculated at operation 238, process flow proceeds to operation 240.

In one embodiment, at operation 240, the horizontal object base field of view percentage is multiplied by the full horizontal field of view to obtain dimensions of the base portion of the object to be measured.

In one embodiment, once the dimensions of the base portion of the object are obtained at operation 240, process flow proceeds to operation 242. In one embodiment, at operation 242, the calculated dimensions of the object are provided to the user.

FIG. 7E is a screenshot 700E of an object measurement interface, which is an illustrative example of calculated object dimensions being provided to a user, in accordance with one embodiment.

As shown in FIG. 7E, in one embodiment, once the tree dimensions have been calculated, an information display portion of the object measurement interface displays the calculated dimensions of the object as shown by object dimensions display area 720. In one embodiment, the user is also notified that measurements have been completed.

As noted above, in some embodiments, the object measurement interface is offered as a stand-alone tool for use in measurement of a wide variety of objects. In other embodiments, the object measurement interface is offered as part of a larger project management system, such as, but not limited to, an arboriculture services project management system. In the embodiment where the interface is offered as part of a larger project management system, once the measurements have been completed, the user may select a button, such as return to web app button 722, which may transfer the user back to an interface associated with the project management system.

In one embodiment, once the calculated dimensions of the object are provided to the user at operation 242, process flow proceeds to END operation 244 where process 200C is exited to await new data.

Referring back to FIG. 4F, as noted above, in one embodiment when the user is in multi-image mode, the image of the leftmost portion of the object and the image of the rightmost portion of the object may be combined to generate a horizontal panoramic image 414. Similarly, the image of the base/bottom portion of the object and the image of the topmost portion of the object are combined to generate a vertical panoramic image 416. In one embodiment, the horizontal and vertical panoramic images are presented to the user for review and/or approval through the object measurement interface upon completion of the image capture process. In one embodiment, in addition to and/or instead of presenting the panoramic images to the user through the object measurement interface, the panoramic images are presented to the user through a user interface of a larger project management system, as shown in FIG. 1F, discussed above.

In one embodiment, in order to construct the panoramic images, a mobile computer vision library, such as OpenCV, is utilized to stitch the left and right images into a horizontal panorama and the base and top images into a vertical panorama. In one embodiment, a built in homography calculator of OpenCV is utilized to provide hints about which images are horizontal and which are vertical. In other embodiments, the captured rotation data is utilized to build a custom homography calculator for OpenCV utilizing precise camera movements, which improves the quality of the panoramic image.

In one embodiment, the images are then presented to the user for confirmation, as shown in FIG. 4F. If the images cannot be combined, all four constituent images are presented rather than the two panoramas. In general, to build a panoramic image, a homography from the camera to the captured image is created. Using the homography, a virtual camera offset can be generated to determine the lines to stitch the pixels over in the panoramic image.

The built in homography calculator of OpenCV relies on identification features in the image to guess the camera offset, which is not a reliably accurate method of determining camera offset. For example, the image features that the built in homography calculator uses to guess the camera offset varies from image to image pretty dramatically.

Thus, in some embodiments a custom homography calculator is provided by the methods and systems disclosed herein, which provides a direct homography. As one illustrative example, using the rotation data collected, a direct homography can be provided indicating that the camera was shifted 35 degrees up, 11 degrees right, and moved forward by 2 feet between image captures. Utilizing the custom homography calculator dramatically increases the quality of the panoramic images generated for displaying to the user.

In one embodiment, the methods and systems disclosed herein include a computing device configured for object measurement, wherein the computing device comprises one or more optical components, an inertial measurement unit (IMU), a display screen, at least one processor, and at least one memory coupled to the at least one processor, the at least one memory having stored therein instructions which, when executed by the at least one processor, perform a measurement process.

In one embodiment, the measurement process includes using IMU data generated by the IMU to construct a virtual 3D environment model representing a current physical environment of a user of the computing device. In one embodiment, the measurement process further includes using the one or more optical components of the computing device to capture object image data representing data associated with one or more images of an object to be measured, and using the IMU data to obtain object image location data representing a location of the computing device in the virtual 3D environment model at the time the object image data was captured. The object image data is then used to obtain object edge data representing data associated with one or more edges of the object to be measured.

In one embodiment the measurement process further includes using the one or more optical components of the computing device to capture object base image data representing data associated with an image of a base portion of the object to be measured, and using the IMU data, to obtain object base image location data representing a location of the computing device in the virtual 3D environment model at the time the object base image data was captured. In one embodiment, the object image location data, the object base image location data, and the object edge data, are used to calculate one or more object dimensions of the object to be measured, and the one or more object dimensions are provided to the user of the computing device.

In one embodiment, calculating one or more object dimensions of the object to be measured includes generating full field of view data, including full horizontal field of view and full vertical field of view, calculating a pixel density ratio, calculating object edge offsets based on the pixel density ratio and the object edge data, calculating object field of view percentages based on the pixel density ratio and the object edge offsets, and utilizing the full field of view data and the object field of view percentages to calculate dimensions of the object to be measured.

In one embodiment, generating full field of view data includes obtaining intrinsic field of view data associated with the one or more optical components of the computing device, generating total distance data representing a distance between the object image location specified by the object image location data and the location of the object to be measured, and utilizing the intrinsic field of view data and the total distance data to calculate full horizontal field of view and full vertical field of view.

In one embodiment, the total distance data is generated by placing a virtual object image location marker within the virtual 3D environment model at the location specified by the object image location data, placing a virtual object base image location marker within the virtual 3D environment model at the location specified by the object base image location data, calculating a first distance representing a distance between the virtual object image location marker and the virtual object base image location marker, calculating a second distance representing a distance between the virtual object base image location marker and the object to be measured, and calculating a sum of the first distance and the second distance.

In one embodiment, calculating the pixel density ratio includes obtaining pixel density data associated with the one or more optical components of the computing device, and utilizing the full field of view data and the pixel density data to calculate the pixel density ratio, wherein the pixel density ratio represents a pixel density of an optical component of the computing device relative to a pixel density of the display screen of the computing device. In one embodiment, calculating object edge offsets based on the pixel density ratio and the object edge data further includes calculating a horizontal object edge offset and calculating a vertical object edge offset. In one embodiment, calculating object field of view percentages based on the pixel density ratio and the object edge offsets further includes calculating a horizontal object field of view percentage and calculating a vertical object field of view percentage.

In one embodiment, obtaining object edge data representing data associated with of one or more edges of the object to be measured includes utilizing the display screen to obtain display screen coordinates of the one or more edges of the object to be measured. In one embodiment the measurement process further includes using the IMU data to obtain object image rotation data representing a rotation of the computing device in the virtual 3D environment model at the time the object image data was captured, and obtaining object edge data representing data associated with of one or more edges of the object to be measured. In one embodiment, obtaining object edge data includes utilizing the captured object image data, along with the associated object image location data and object image rotation data to calculate total horizontal deflection of the computing device between a leftmost and rightmost image represented by the captured object image data and total vertical deflection of the computing device between a bottom and topmost image represented by the captured object image data.

In one embodiment, the measurement process further includes using the device display screen and the object base image data to obtain object base edge data representing display screen coordinates of one or more edges of the base portion of the object to be measured, and calculating, using the object image location data, the object base image location data, and the object base edge data, one or more object base dimensions of the base portion of the object to be measured.

In one embodiment, the methods and systems disclosed herein include a computer-implemented method for object measurement comprising providing a user with an object measurement interface accessible through a computing device of the user, and utilizing the object measurement interface and one or more processors of the computing device to perform the above described measurement process.

In one embodiment, the methods and systems disclosed herein include a method for providing enhanced arboriculture service estimates comprising providing a user with an arboriculture services project management system, utilizing a project management user interface of the project management system to define project specifications, identifying one or more project specifications that require vegetation analysis, providing the user with a vegetation analysis tool through the project management system, utilizing the vegetation analysis tool to obtain one or more images of the vegetation to be analyzed, utilizing the vegetation analysis tool to generate vegetation dimensions data representing measurements of one or more dimensions of the vegetation to be analyzed, and utilizing the vegetation dimensions data to update the one or more project specifications, wherein the one or more project specifications include a project cost estimate.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

In addition, the operations shown in the figures, or as discussed herein, are identified using a particular nomenclature for ease of description and understanding, but other nomenclature is often used in the art to identify equivalent operations. Therefore, numerous variations, whether explicitly provided for by the specification or implied by the specification or not, may be implemented by one of skill in the art in view of this disclosure.

What is claimed is:

1. A computing device configured for object measurement comprising:
one or more optical components;
an inertial measurement unit (IMU);
a display screen;
at least one processor; and
at least one memory coupled to the at least one processor, the at least one memory having stored therein instructions which, when executed by the at least one processor, perform a process including:
constructing, using IMU data generated by the IMU, a virtual 3D environment model representing a current physical environment of a user of the computing device;
capturing, using the one or more optical components of the computing device, object image data representing data associated with one or more images of an object to be measured;
obtaining, using the IMU data, object image location data representing a location of the computing device in the virtual 3D environment model at the time the object image data was captured;
obtaining, using the object image data, object edge data representing data associated with one or more edges of the object to be measured;
capturing, using the one or more optical components of the computing device, object base image data representing data associated with an image of a base portion of the object to be measured;
obtaining, using the IMU data, object base image location data representing a location of the computing device in the virtual 3D environment model at the time the object base image data was captured;
calculating, using the object image location data, the object base image location data, and the object edge data, one or more object dimensions of the object to be measured; and
providing the one or more object dimensions to the user of the computing device.

2. The computing device of claim 1 wherein calculating one or more object dimensions of the object to be measured includes:
generating full field of view data, including full horizontal field of view and full vertical field of view;
calculating a pixel density ratio;
calculating object edge offsets based on the pixel density ratio and the object edge data;
calculating object field of view percentages based on the pixel density ratio and the object edge offsets; and
utilizing the full field of view data and the object field of view percentages to calculate dimensions of the object to be measured.

3. The computing device of claim 2 wherein generating full field of view data includes:
obtaining intrinsic field of view data associated with the one or more optical components of the computing device;
generating total distance data representing a distance between the object image location specified by the object image location data and the location of the object to be measured; and
utilizing the intrinsic field of view data and the total distance data to calculate full horizontal field of view and full vertical field of view.

4. The computing device of claim 3 wherein the total distance data is generated by:
placing a virtual object image location marker within the virtual 3D environment model at the location specified by the object image location data;
placing a virtual object base image location marker within the virtual 3D environment model at the location specified by the object base image location data;
calculating a first distance representing a distance between the virtual object image location marker and the virtual object base image location marker;
calculating a second distance representing a distance between the virtual object base image location marker and the object to be measured; and
calculating a sum of the first distance and the second distance.

5. The computing device of claim 2 wherein calculating the pixel density ratio includes:
obtaining pixel density data associated with the one or more optical components of the computing device; and
utilizing the full field of view data and the pixel density data to calculate the pixel density ratio, wherein the pixel density ratio represents a pixel density of an optical component of the computing device relative to a pixel density of the display screen of the computing device.

6. The computing device of claim 2 wherein calculating object edge offsets based on the pixel density ratio and the object edge data further includes:
calculating a horizontal object edge offset; and
calculating a vertical object edge offset.

7. The computing device of claim 2 wherein calculating object field of view percentages based on the pixel density ratio and the object edge offsets further includes:
calculating a horizontal object field of view percentage; and
calculating a vertical object field of view percentage.

8. The computing device of claim 1 wherein obtaining object edge data representing data associated with of one or more edges of the object to be measured includes utilizing the display screen to obtain display screen coordinates of the one or more edges of the object to be measured.

9. The computing device of claim 1 further including obtaining, using the IMU data, object image rotation data representing a rotation of the computing device in the virtual 3D environment model at the time the object image data was captured.

10. The computing device of claim 9 wherein obtaining object edge data representing data associated with of one or more edges of the object to be measured includes utilizing the captured object image data, along with the associated object image location data and object image rotation data to calculate:
total horizontal deflection of the computing device between a leftmost and rightmost image represented by the captured object image data; and
total vertical deflection of the computing device between a bottom and topmost image represented by the captured object image data.

11. The device of claim 1 further including obtaining, using the device display screen and the object base image data, object base edge data representing display screen coordinates of one or more edges of the base portion of the object to be measured.

12. The computing device of claim 8 further including calculating, using the object image location data, the object base image location data, and the object base edge data, one or more object base dimensions of the base portion of the object to be measured.

13. A computer-implemented method for object measurement comprising:
providing a user with an object measurement interface accessible through a computing device of the user;
utilizing the object measurement interface and one or more processors of the computing device to:
construct a virtual 3D environment model representing a current physical environment of the user;
capture and store object image data, wherein the object image data represents data associated with one or more images of an object to be measured;
obtain object image location data representing a location of the computing device in the virtual 3D environment model at the time the object image data was captured;
utilize the object image data to obtain object edge data representing data associated with one or more edges of the object to be measured;
capture and store object base image data representing data associated with an image of a base portion of the object to be measured;
obtain object base image location data representing a location of the computing device in the virtual 3D environment model at the time the object base image data was captured;
utilize the object image location data, the object base image location data, and the object edge data to calculate one or more object dimensions of the object to be measured; and
provide the one or more object dimensions to the user of the computing device.

14. The computer-implemented method of claim 13 wherein calculating one or more object dimensions of the object to be measured includes:
generating full field of view data, including full horizontal field of view and full vertical field of view;
obtaining pixel density data associated with the one or more optical components of the computing device;
utilizing the full field of view data and the pixel density data to calculate a pixel density ratio, wherein the pixel density ratio represents a pixel density of an optical component of the computing device relative to a pixel density of the display screen of the computing device;
calculating object edge offsets based on the pixel density ratio and the object edge data;
calculating object field of view percentages based on the pixel density ratio and the object edge offsets; and
utilizing the full field of view data and the object field of view percentages to calculate dimensions of the object to be measured.

15. The computer-implemented method of claim 14 wherein generating full field of view data includes:
obtaining intrinsic field of view data associated with one or more optical components of the computing device;
generating total distance data representing a distance between the object image location specified by the object image location data and the location of the object to be measured; and
utilizing the intrinsic field of view data and the total distance data to calculate full horizontal field of view and full vertical field of view.

16. The computer-implemented method of claim 15 wherein the total distance data is generated by:
placing a virtual object image location marker within the virtual 3D environment model at the location specified by the object image location data;
placing a virtual object base image location marker within the virtual 3D environment model at the location specified by the object base image location data;
calculating a first distance representing a distance between the virtual object image location marker and the virtual object base image location marker;
calculating a second distance representing a distance between the virtual object base image location marker and the object to be measured; and
calculating a sum of the first distance and the second distance.

17. The computer-implemented method of claim 13 wherein obtaining object edge data representing data associated with of one or more edges of the object to be measured includes utilizing a display screen of the computing device to obtain display screen coordinates of the one or more edges of the object to be measured.

18. The computer-implemented method of claim 13 wherein obtaining object edge data representing data associated with of one or more edges of the object to be measured includes:
obtaining image rotation data representing a rotation of the computing device in the virtual 3D environment model at the time the object image data was captured; and
utilizing the captured object image data, along with the associated object image location data and object image rotation data to calculate:
total horizontal deflection of the computing device between a leftmost and rightmost image represented by the captured object image data; and
total vertical deflection of the computing device between a bottom and topmost image represented by the captured object image data.

19. The computer-implemented method of claim 13 further including:
obtaining object base edge data representing display screen coordinates of one or more edges of the base portion of the object to be measured; and
calculating one or more object base dimensions of the base portion of the object to be measured.

20. A method for providing enhanced arboriculture service estimates comprising:
providing a user with an arboriculture services project management system;
utilizing a project management user interface of the project management system to define project specifications;
identifying one or more project specifications that require vegetation analysis;
providing the user with a vegetation analysis tool through the project management system;
utilizing the vegetation analysis tool to obtain one or more images of the vegetation to be analyzed;
utilizing the vegetation analysis tool to generate vegetation dimensions data representing measurements of one or more dimensions of the vegetation to be analyzed; and
utilizing the vegetation dimensions data to update the one or more project specifications, wherein the one or more project specifications include a project cost estimate.
